(19) United States
(12) Patent Application Publication
(10) Pub. No.: US 2015/0103782 A1
(43) Pub. Date: Apr. 16, 2015

(54) TECHNIQUES FOR ENABLING ASYNCHRONOUS COMMUNICATIONS USING UNLICENSED RADIO FREQUENCY SPECTRUM

(71) Applicant: QUALCOMM INCORPORATED, San Diego, CA (US)

(72) Inventors: Hao XU, San Diego, CA (US); Wanshi CHEN, San Diego, CA (US); Naga BHUSHAN, San Diego, CA (US); Peter GAAL, San Diego, CA (US); Tingfang JI, San Diego, CA (US); Tao LUO, San Diego, CA (US); Yongbin WEI, San Diego, CA (US); Durga Prasad MALLADI, San Diego, CA (US); Shimman Arvind PATEL, San Diego, CA (US)

(21) Appl. No.: 14/513,035

(22) Filed: Oct. 13, 2014

Related U.S. Application Data
(60) Provisional application No. 61/890,793, filed on Oct. 14, 2013.

(51) Int. Cl. H04W 56/00; H04W 72/04

(52) U.S. Cl. CPC H04W 56/0005; H04W 72/0453
USPC 370/329

(57) ABSTRACT

Certain aspects of the present disclosure relate to techniques that may help address issues in wireless communications systems that utilize unlicensed radio frequency spectrum bands. For example, the techniques presented herein may be used in systems where frames transmitted in licensed and/or un-licensed component carriers are not synchronous.

### CLAIM OF PRIORITY UNDER 35 U.S.C. §119

This application claims benefit of U.S. Provisional Patent Application Ser. No. 61/890,793, filed Oct. 14, 2013 and entitled “TECHNIQUES FOR ENABLING ASYNCHRONOUS COMMUNICATIONS FOR LTE SYSTEMS USING UNLICENSED RADIO FREQUENCY SPECTRUM,” which is herein incorporated by reference in its entirety.

### FIELD

The present disclosure relates generally to wireless communication, and more particularly, to techniques for enabling asynchronous communications using unlicensed radio frequency spectrum (URFS).

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

As the demand for mobile broadband access continues to increase, using LTE in an unlicensed radio frequency spectrum has been considered to solve the spectrum congestion problem for future wireless needs, not only to meet the growing demand for mobile broadband access, but to advance and enhance the user experience with mobile communications. However, unlicensed radio frequency spectrum may carry other transmissions, requiring techniques, such as listen before talk (LBT) and clear channel assessment (CCA), to prevent excessive interference. These techniques present challenges when using current radio frame formats.

### SUMMARY

Aspects of the present disclosure provide techniques for enabling asynchronous communication using unlicensed radio frequency spectrum. For example, a method for enabling asynchronous communication using unlicensed radio frequency spectrum may include determining a first component carrier, from a first set of component carriers within a licensed radio frequency spectrum band allocated between a plurality of operators, determining a second component carrier, from a second set of component carriers within an unlicensed radio frequency spectrum band allocated between the plurality of operators, and communicating using the first component carrier and the second component carrier.

In accordance with another aspect, a method for enabling asynchronous communication using unlicensed radio frequency spectrum may include identifying a first set of component carriers within a licensed radio frequency spectrum band used by one or more operators of a plurality of operators, identifying a second set of component carriers within an unlicensed radio frequency spectrum band used by one or more operators of the plurality of operators, selecting a first component carrier from the first set of component carriers, selecting a second component carrier from the second set of component carriers, and communicating using the selected first and second component carriers, wherein a first frame transmitted using the first component carrier is time asynchronous with a second frame transmitted using the second component carrier and the second frame is time synchronized with frames transmitted using other component carriers of the second set of component carriers.

In accordance with another aspect, a method for processing time shift is provided. The method may include determining a first component carrier within a licensed radio spectrum band, determining a second component carrier within an unlicensed radio spectrum band, determining a time shift between first frames transmitted using the first component carrier and second frames transmitted using the second component carrier, and utilizing the time shift when communicating using at least one of the first or second component carriers.

In accordance with another aspect, a method for wireless communications is provided. The method may include determining a first component carrier, from a first set of component carriers within a licensed radio frequency spectrum band used by different operators, and determining a second component carrier, from a second set of component carriers within an unlicensed radio frequency spectrum band, wherein first frames transmitted using the first component carrier are time asynchronous with second frames transmitted using the second component carrier and the second frames are time synchronized with frames transmitted using other component carriers of the second set of component carriers.

Aspects of the present disclosure provide a method by a user equipment (UE)/base station (BS, eNB, NB, etc.) for wireless communication. An exemplary method may include identifying a set of available component carriers within an unlicensed radio frequency spectrum band used by a plurality of operators, determining, from the set of available component carriers, a set of component carriers that are unused by at least one operator of the plurality of operators, selecting, based on the determination, one or more of the unused component carriers, and using the one or more selected component carriers for communicating.

In accordance with another aspect, a method for wireless communications is provided. The method may include determining a first component carrier of a first operator, from a set of component carriers within a unlicensed radio frequency spectrum band allocated between a plurality of operators, wherein first frames transmitted using the first component carrier are time asynchronous with frames transmitted using other component carriers of the set of component carriers, performing clear channel assessment (CCA) for transmission on the first component carrier, and performing one or more actions when the clear channel assessment fails.

In accordance with another aspect, a method for wireless communications is provided. The method may include determining a first component carrier, from a set of one or more component carriers within an unlicensed radio frequency spectrum band, detecting one or more signals to obtain a timing of transmission, aligning a frame structure to the detected timing of transmission.

Aspects of the present disclosure also provide various apparatuses capable of performing the operations described above and computer readable mediums having instructions stored thereon for performing the operations described above.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a block diagram conceptually illustrating an example of a telecommunications system in accordance with an aspect of the present disclosure.

FIG. 2 is a block diagram conceptually illustrating an example of a down link frame structure in a telecommunications system in accordance with an aspect of the present disclosure.

FIG. 3 is a block diagram conceptually illustrating an exemplary eNodeB and an exemplary UE configured in accordance with an aspect of the present disclosure.

FIG. 4 illustrates various exemplary subframe resource elements mapping in accordance with an aspect of the present disclosure.

FIG. 5 illustrates a contiguous carrier aggregation type in accordance with an aspect of the present disclosure.

FIG. 6 illustrates a non-contiguous carrier aggregation type in accordance with an aspect of the present disclosure.

FIG. 7 illustrates different deployment scenarios for systems utilizing unlicensed radio frequency spectrum bands, in accordance with certain aspects of the disclosure.

FIG. 8 illustrates an example of synchronous operation using clear channel assessment procedures, in accordance with certain aspects of the disclosure.

FIG. 9 illustrates an exemplary deployment of two operators on an asynchronous mode, sharing unlicensed radio frequency spectrum, in accordance with certain aspects of the disclosure.

FIG. 10 illustrates a multi-cell operation with asynchronous deployment with small cells, in accordance with certain aspects of the disclosure.

FIG. 11 illustrates exemplary operations for communicating using component carriers in an unlicensed radio frequency spectrum band, in accordance with certain aspects of the disclosure.

FIG. 12 illustrates an example of a system with different operators communicating using component carriers in an unlicensed radio frequency spectrum band, in accordance with certain aspects of the disclosure.

FIG. 13 illustrates an exemplary channel layout, in accordance with certain aspects of the disclosure.

FIG. 14 illustrates example operations for communicating using component carriers in an unlicensed radio frequency spectrum band, in accordance with certain aspects of the disclosure.

FIG. 15 illustrates an exemplary system with frames transmitted using a component carrier in an unlicensed radio frequency spectrum band aligned with frames transmitted using a component carrier in a licensed radio frequency spectrum band, in accordance with certain aspects of the disclosure.

FIG. 16 illustrates exemplary operations for communicating using component carriers in an unlicensed radio frequency spectrum band, in accordance with certain aspects of the disclosure.

FIG. 17 illustrates an exemplary system with frames transmitted using different component carriers of an unlicensed radio frequency spectrum band aligned in time, in accordance with certain aspects of the disclosure.

FIGS. 18 and 19 illustrate exemplary time shifts between frames transmitted on first and second component carriers, in accordance with certain aspects of the disclosure.

FIGS. 20 and 21 illustrate exemplary techniques to account for a time shift between frames transmitted on first and second component carriers, in accordance with certain aspects of the disclosure.

FIGS. 22-24 illustrate different example techniques for performing clear channel assessment (CCA), in accordance with certain aspects of the disclosure.

FIG. 25 illustrates exemplary operations for communicating using component carriers in an unlicensed radio frequency spectrum band, in accordance with certain aspects of the disclosure.

FIG. 26 illustrates exemplary operations for communicating using component carriers in an unlicensed radio frequency spectrum band, in accordance with certain aspects of the disclosure.

FIG. 27 illustrates exemplary operations for communicating using component carriers in an unlicensed radio frequency spectrum band, in accordance with certain aspects of the disclosure.

FIG. 28 shows a block diagram that illustrates an example of a UE architecture according to various aspects of the disclosure.

FIG. 29 shows a block diagram that illustrates an example of a base station architecture according to various aspects of the disclosure.

### DETAILED DESCRIPTION

Aspects of the present disclosure provide various techniques for enabling asynchronous communications using unlicensed radio frequency spectrum (URFS). For example, a technique for enabling asynchronous communications using URFS may include communicating using component carriers in a licensed radio frequency spectrum (LRFS) band and component carriers in a URFS band. The techniques may be applied to selecting one or more component carriers in the LRFS band as well as one or more component carriers in the URFS band. The techniques may also be applied to determining timing offsets between different component carriers when the transmissions using different component carriers are asynchronous.

In some aspects of the present disclosure, component carriers in the LRFS band may be time aligned with component carriers in the URFS band, while component carriers in the URFS band may not be aligned with each other. In other aspects of the present disclosure, component carriers in the LRFS band may not be aligned with component carriers in the URFS band, while component carriers in the URFS band may be aligned with each other. Aspects of the present disclosure may help alleviate frequency spectrum congestion.

The detailed description set forth below in connection with the appended drawings is intended as a description of various aspects of the present disclosure and is not intended to represent the only aspects of the present disclosure in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

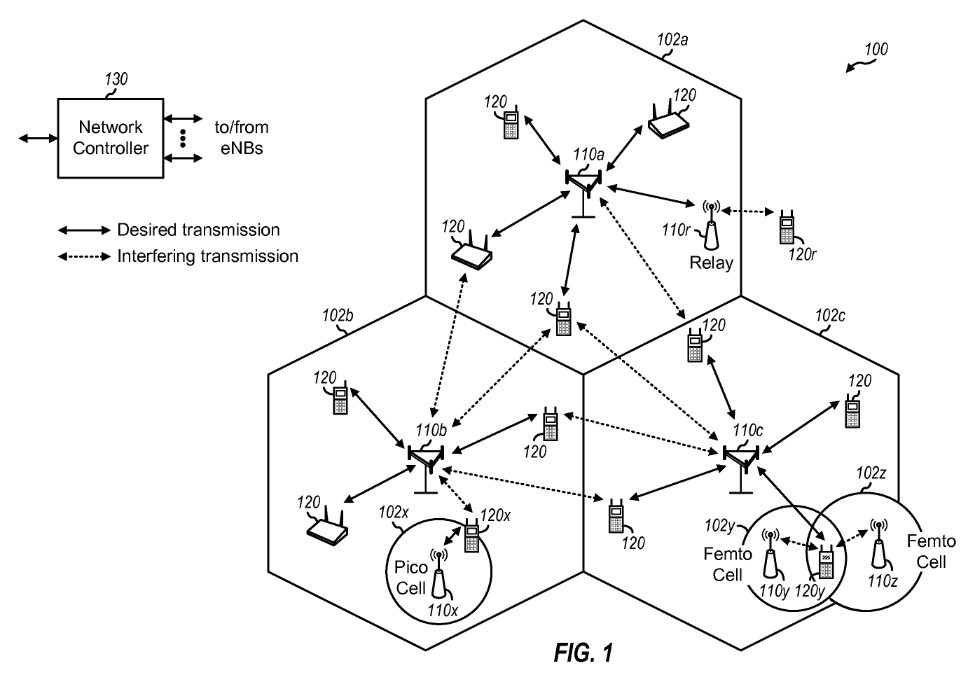

FIG. 1 is a block diagram conceptually illustrating an example of a telecommunications network system 100 in accordance with an aspect of the present disclosure. For example, the telecommunications network system 100 may be an LTE network. The telecommunications network system 100 may include a number of evolved NodeBs (eNodeBs) 110 and user equipment (UEs) 120 and other network entities, some or all of which may be capable of communicating on component carriers in an LRFS band and component carriers in a URFS band, in accordance with certain aspects of the present disclosure as described herein.

An eNodeB 110 may be a station that communicates with the UEs 120 and may also be referred to as a base station, an access point, etc. A NodeB is another example of a station that communicates with the UEs 120.

Each eNodeB 110 may provide communication coverage for a particular geographic area. In 3GPP, the term “cell” can refer to a coverage area of an eNodeB 110 and/or an eNodeB subsystem serving the coverage area, depending on the context in which the term is used. As will be described in greater detail below, some cells may use component carriers in an LRFS band, while others may use component carriers in a URFS band.

An eNodeB 110 may provide communication coverage for a macro cell, a pico cell, a femto cell, and/or other types of cell. A macro cell may cover a relatively large geographic area (e.g., several kilometers in radius) and may allow unrestricted access by UEs 120 with service subscription. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 may be subscribed to a Closed Subscriber Group (CSG), UEs 120 for users in the home, etc.). An eNodeB 110 for a macro cell may be referred to as a macro eNodeB. An eNodeB 110 for a pico cell may be referred to as a pico eNodeB. An eNodeB 110 for a femto cell may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x. The eNodeBs 110y and 110z may be femto eNodeBs for the femto cells 102y and 102z, respectively. An eNodeB 110 may provide communication coverage for one or more (e.g., three) cells.

The telecommunications network system 100 may include one or more relay stations 110r and 120r, that may also be referred to as a relay eNodeB, a relay, etc. The relay station 110r may be a station that receives a transmission of data and/or other information from an upstream station (e.g., an eNodeB 110 or a UE 120) and sends the received transmission of the data and/or other information to a downstream station (e.g., a UE 120 or an eNodeB 110). The relay station 120r may be a UE that relays transmissions for other UEs (not shown). In the example shown in FIG. 1, the relay station 110r may communicate with the eNodeB 110a and the UE 120r in order to facilitate communication between the eNodeB 110a and the UE 120r.

The telecommunications network system 100 may be a heterogeneous network that includes eNodeBs 110 of different types, e.g., macro eNodeBs 110a -c, pico eNodeBs 110x, femto eNodeBs 110y -z, relays 110r, etc. These different types of eNodeBs 110 may have different transmit power levels, different coverage areas, and different impact on interference in the telecommunications network system 100. For example, macro eNodeBs 110a -c may have a high transmit power level (e.g., 20 Watts) whereas pico eNodeBs 110x, femto eNodeBs 110y-z and relays 110r may have a lower transmit power level (e.g., 1 Watt).

The telecommunications network system 100 may support synchronous or asynchronous operation. For synchronous operation, the eNodeBs 110 may have similar frame timing, and transmissions from different eNodeBs 110 may be approximately aligned in time. For asynchronous operation, the eNodeBs 110 may have different frame timing, and transmissions from different eNodeBs 110 and may not be aligned in time. The techniques described herein may be used for both synchronous and asynchronous operation. As noted above, some component carriers in LRFS and URFS bands may be synchronous, while other component carriers in LRFS and URFS bands may be asynchronous.

A network controller 130 may be coupled to a set of eNodeBs 110 and provide coordination and control for these eNodeBs 110. The network controller 130 may communicate with the eNodeBs 110 via a backhaul (not shown). The eNodeBs 110 may also communicate with one another, e.g., directly or indirectly via wireless or wire line backhaul (e.g., X2 interface) (not shown).

The UEs 120 (e.g., 120x, 120y, etc.) may be dispersed throughout the telecommunications network system 100, and each UE 120 may be stationary or mobile. For example, the UE 120 may be referred to as a terminal, a mobile station, a subscriber unit, a station, etc. In another example, the UE 120 may be a cellular phone, a personal digital assistant (PDA), a wireless modem, a wireless communication device, a handheld device, a laptop computer, a cordless phone, a wireless local loop (WLL) station, a tablet, a netbook, a smart book, etc. The UE 120 may be able to communicate with macro eNodeBs 110a -c, pico eNodeBs 110x, femto eNodeBs 110y-z, relays 110r, etc. For example, in FIG. 1, a solid line with double arrows may indicate desired transmissions between a UE 120 and a serving eNodeB 110, which is an eNodeB 110 designated to serve the UE 120 on the downlink and/or uplink. A dashed line with double arrows may indicate interfering transmissions between a UE 120 and an eNodeB 110.

LTE may utilize orthogonal frequency division multiplexing (OFDM) on the downlink and single-carrier frequency division multiplexing (SC-FDM) on the uplink. OFDM and SC-FDM may partition the system bandwidth into multiple (K) orthogonal subcarriers, which are also commonly referred to as tones, bins, etc. Each subcarrier may be modulated with data. In general, modulation symbols may be sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal Fast Fourier Transform (FFT) size may be equal to 128, 256, 512, 1024 or 2048 for system bandwidth of 1.25, 2.5, 5, 10 or 20 megahertz (MHz), respectively. The system bandwidth may be partitioned into subbands. For example, a subband may cover 1.08 MHz (i.e.,6 resource blocks), and there may be 1, 2, 4, 8 or 16 subbands for system bandwidth of 1.25, 2.5, 5, 10 or 20 MHz, respectively.

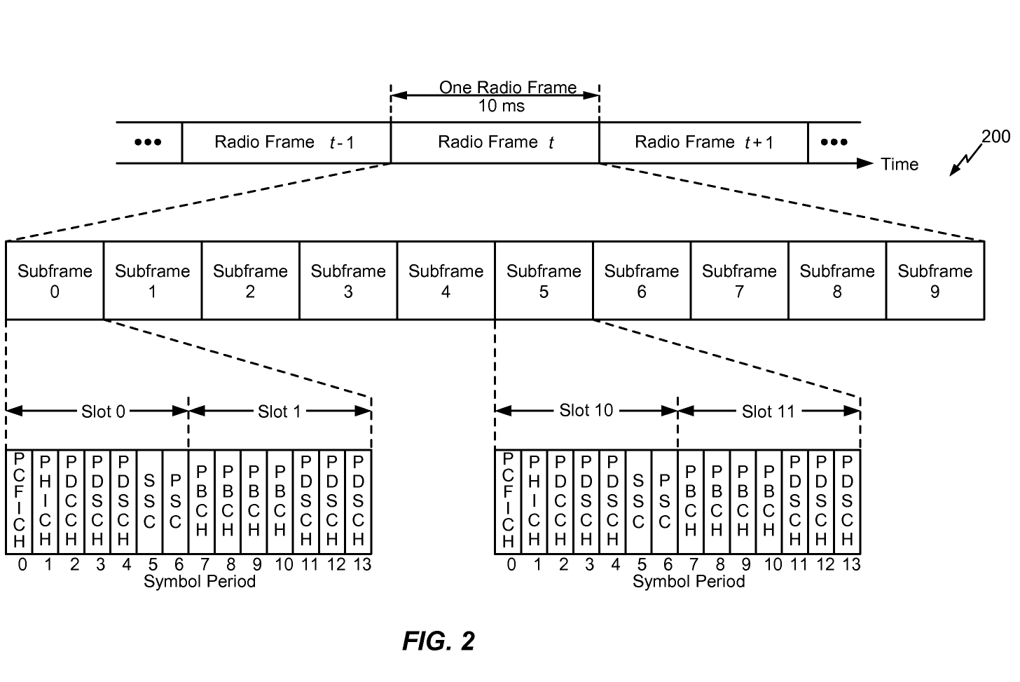

FIG. 2 is a block diagram conceptually illustrating an example of a down link frame structure in a telecommunications system in accordance with an aspect of the present disclosure. Depending on the particular implementation, transmissions using such frame structures may be time aligned between certain component carriers and not time aligned between other component carriers.

The transmission timeline for the downlink may be partitioned into units of radio frames. Each radio frame may have a predetermined duration (e.g., 10 milliseconds (ms)) and may be partitioned into 10 sub-frames with indices of 0 through 9. Each sub-frame may include two slots. Each radio frame may thus include 20 slots with indices of 0 through 23.Each slot may include L symbol periods, e.g., 7 symbol periods for a normal cyclic prefix (as shown in FIG. 2) or 14 symbol periods for an extended cyclic prefix (not shown). The 2L symbol periods in each sub-frame may be assigned indices of 0 through 2L-1. The available time frequency resources may be partitioned into resource blocks. Each resource block may cover N subcarriers (e.g., 12 subcarriers) in one slot.

In LTE for example, an eNodeB may send a primary synchronization signal (PSS) and a secondary synchronization signal (SSS) for each cell in the coverage area of the eNodeB. The primary synchronization signal (PSS) and secondary synchronization signal (SSS) may be sent in symbol periods 6 and 5, respectively, in each of sub-frames 0 and 5 of each radio frame with the normal cyclic prefix, as shown in FIG. 2. The synchronization signals may be used by UEs for cell detection and acquisition. The eNodeB may send system information in a Physical Broadcast Channel (PBCH) in symbol periods 0 to 3 of slot 1 of sub-frame 0.

The eNodeB may send information in a Physical Control Format Indicator Channel (PCFICH) in only a portion of the first symbol period of each sub-frame, although depicted in the entire first symbol period in FIG. 2. The PCFICH may convey the number of symbol periods (M) used for control channels, where M may be equal to 1, 2 or 3 and may change from sub-frame to sub-frame. M may also be equal to 4 for a small system bandwidth, e.g., with less than 10 resource blocks. In the example shown in FIG. 2, M=3. The eNodeB may send information in a Physical HARQ Indicator Channel (PHICH) and a Physical Downlink Control Channel (PDCCH) in the first M symbol periods of each sub-frame (M=3 in FIG. 2). The PHICH may carry information to support hybrid automatic retransmission (HARQ). The PDCCH may carry information on uplink and downlink resource allocation for UEs and power control information for uplink channels. Although not shown in the first symbol period in FIG. 2, it may be understood that the PDCCH and PHICH are also included in the first symbol period. Similarly, the PHICH and PDCCH are also both in the second and third symbol periods, although not shown that way in FIG. 2. The eNodeB may send information in a Physical Downlink Shared Channel (PDSCH) in the remaining symbol periods of each sub-frame. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH around the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs in the coverage area. The eNodeB may send the PDCCH in a unicast manner to specific UEs in the coverage area. The eNodeB may also send the PDSCH in a unicast manner to specific UEs in the coverage area.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage areas of multiple eNodeBs. One of these eNodeBs may be selected to serve the UE. The serving eNodeB may be selected based on various criteria such as received power, path loss, signal-to-noise ratio (SNR), etc.

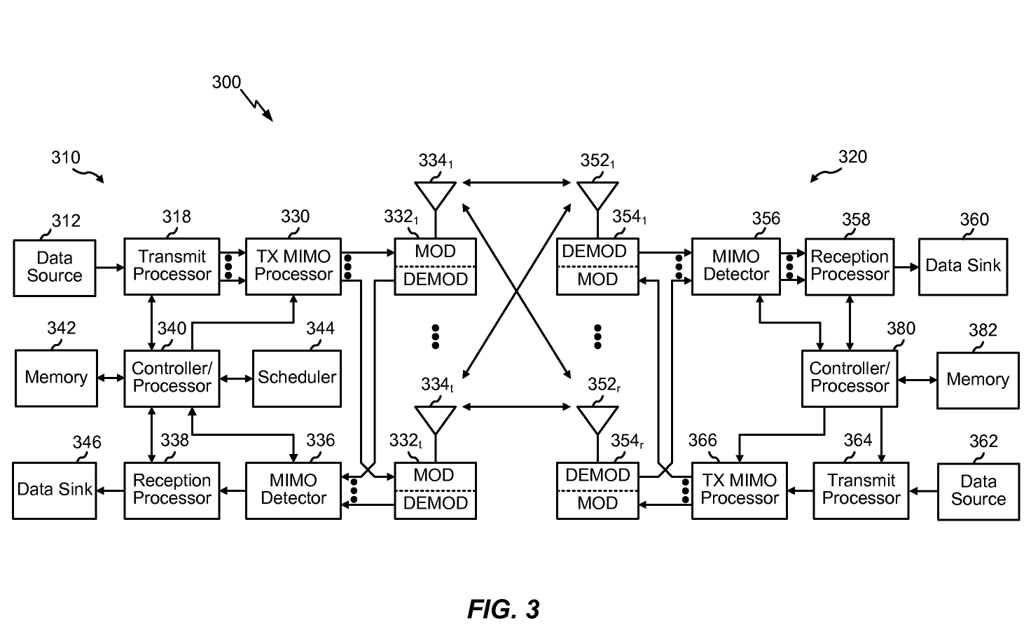

FIG. 3 is a block diagram conceptually illustrating an exemplary eNodeB 310 and an exemplary UE 320 configured to communicate using component carriers of an LRFS band and component carriers of a URFS band in accordance with an aspect of the present disclosure. For example, the base station/eNodeB 310 and the UE 320, as shown in FIG. 3, may be one of the base stations/eNodeBs and one of the UEs in FIG. 1. The base station 310 may be equipped with antennas 334₁₋ₜ, and the UE 320 may be equipped with antennas 352₁₋ᵣ, wherein t and r are integers greater than or equal to one.

At the base station 310, a base station transmit processor 318 may receive data from a base station data source 312 and control information from a base station controller/processor 340. The control information may be carried on the PBCH, PCFICH, PHICH, PDCCH, etc. The data may be carried on the PDSCH, etc. The base station transmit processor 318 may process (e.g., encode and symbol map) the data and control information to obtain data symbols and control symbols, respectively. The base station transmit processor 318 may also generate reference symbols, e.g., for the PSS, SSS, and cell-specific reference signal (RS). A base station transmit (TX) multiple-input multiple-output (MIMO) processor 330 may perform spatial processing (e.g., precoding) on the data symbols, the control symbols, and/or the reference symbols, if applicable, and may provide output symbol streams to the base station modulators/demodulators (MODs/DEMODs) 332₁₋ₜ. Each base station modulator/demodulator 332 may process a respective output symbol stream (e.g., for OFDM, etc.) to obtain an output sample stream. Each base station modulator/demodulator 332 may further process (e.g., convert to analog, amplify, filter, and upconvert) the output sample stream to obtain a downlink signal. Downlink signals from modulators/demodulators 332₁₋ₜ may be transmitted via the antennas 334₁₋ₜ, respectively.

At the UE 320, the UE antennas 352₁₋ᵣ, may receive the downlink signals from the base station 310 and may provide received signals to the UE modulators/demodulators (MODs/DEMODs) 354₁₋ᵣ, respectively. Each UE modulator/demodulator 354 may condition (e.g., filter, amplify, downconvert, and digitize) a respective received signal to obtain input samples. Each UE modulator/demodulator 354 may further process the input samples (e.g., for OFDM, etc.) to obtain received symbols. A UE MIMO detector 356 may obtain received symbols from all the UE modulators/demodulators 354₁₋ᵣ, and perform MIMO detection on the received symbols if applicable, and provide detected symbols. A UE reception processor 358 may process (e.g., demodulate, de-interleave, and decode) the detected symbols, provide decoded data for the UE 320 to a UE data sink 360, and provide decoded control information to a UE controller/processor 380.

On the uplink, at the UE 320, a UE transmit processor 364 may receive and process data (e.g., for the PUSCH) from a UE data source 362 and control information (e.g., for the PUCCH) from the UE controller/processor 380. The UE transmit processor 364 may also generate reference symbols for a reference signal. The symbols from the UE transmit processor 364 may be precoded by a UE TX MIMO processor 366 if applicable, further processed by the UE modulators/demodulators 354₁₋ᵣ (e.g., for SC-FDM, etc.), and transmitted to the base station 310. At the base station 310, the uplink signals from the UE 320 may be received by the base station antennas 334, processed by the base station modulators/demodulators 332, detected by a base station MIMO detector 336 if applicable, and further processed by a base station reception processor 338 to obtain decoded data and control information sent by the UE 320. The base station reception processor 338 may provide the decoded data to a base station data sink 346 and the decoded control information to the base station controller/processor 340.

The base station controller/processor 340 and the UE controller/processor 380 may direct the operation at the base station 310 and the UE 320, respectively. The base station controller/processor 340 and/or other processors and modules at the base station 310 may perform or direct, e.g., the execution of various processes for the techniques described herein. The UE controller/processor 380 and/or other processors and modules at the UE 320 may also perform or direct, e.g., the execution of the functional blocks illustrated in the figures, and/or other processes for the techniques described herein. The base station memory 342 and the UE memory 382 may store data and program codes for the base station 310 and the UE 320, respectively. A scheduler 344 may schedule UEs 320 for data transmission on the downlink and/or uplink.

In an aspect of the present disclosure, the base station 310 may include means for generating a compact Downlink Control Information (DCI) for at least one of uplink (UL) or downlink (DL) transmissions, wherein the compact DCI comprises a reduced number of bits when compared to certain standard DCI formats; and means for transmitting the DCI. In one aspect, the aforementioned means may be the base station controller/processor 340, the base station memory 342, the base station transmit processor 318, the base station modulators/demodulators 332, and the base station antennas 334 configured to perform the functions recited by the aforementioned means. In another aspect, the aforementioned means may be a module or any apparatus configured to perform the functions recited by the aforementioned means. In an aspect of the present disclosure, the UE 320 may include means for receiving compact Downlink Control Information (DCI) for at least one of uplink (UL) or downlink (DL) transmissions, wherein the DCI comprises a reduced number of bits of a standard DCI format; and means for processing the DCI. In one aspect, the aforementioned means may be the UE controller/processor 380, the UE memory 382, the UE reception processor 358, the UE MIMO detector 356, the UE modulators/demodulators 354, and the UE antennas 352 configured to perform the functions recited by the aforementioned means. In another aspect, the aforementioned means may be a module or any apparatus configured to perform the functions recited by the aforementioned means.

In an aspect of the present disclosure, the base station 310 or UE 320 may include means for performing various operations described herein for communicating using component carriers in LRFS and URFS bands. For example, the base station 310 or UE 320 may include means for determining a first component carrier for a first operator, from a set of component carriers within a URFS band used by a plurality of operators, wherein the first component carrier is different from a second component carrier from the set of component carriers used by a second operator of the plurality of operators and means for communicating using the first component carrier. In one aspect of the present disclosure, the base station 310 or UE 320 may include means for performing clear channel assessment (CCA) to gain access to a URFS band for transmission on the first component carrier; and means for performing one or more actions when the clear channel assessment fails (e.g., adjusting a duration of the CCA window). In another aspect of the present disclosure, the base station 310 or UE 320 may include means for detecting one or more signals to obtain a timing of transmission; and means for aligning a frame structure to the detected timing of transmission.

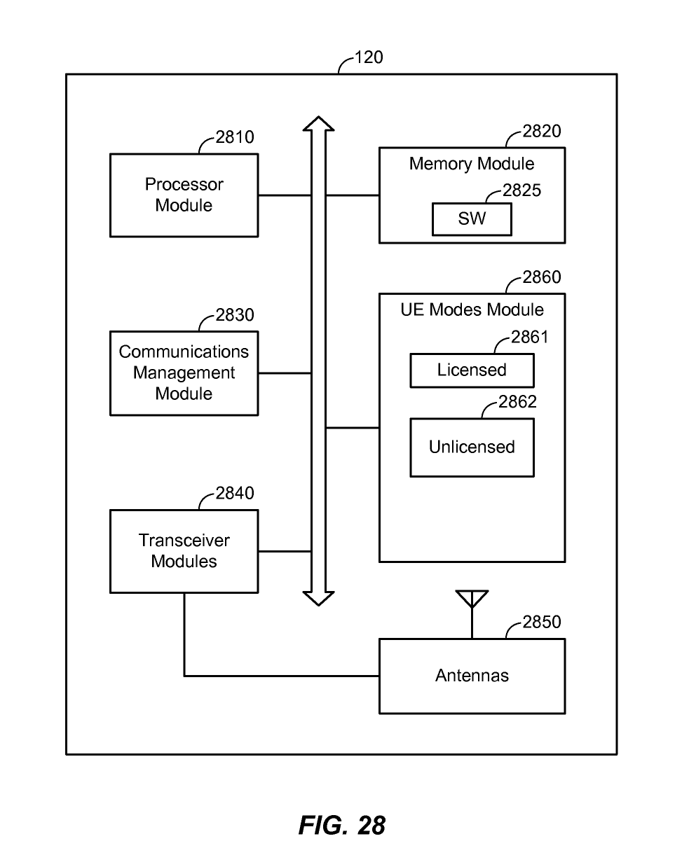

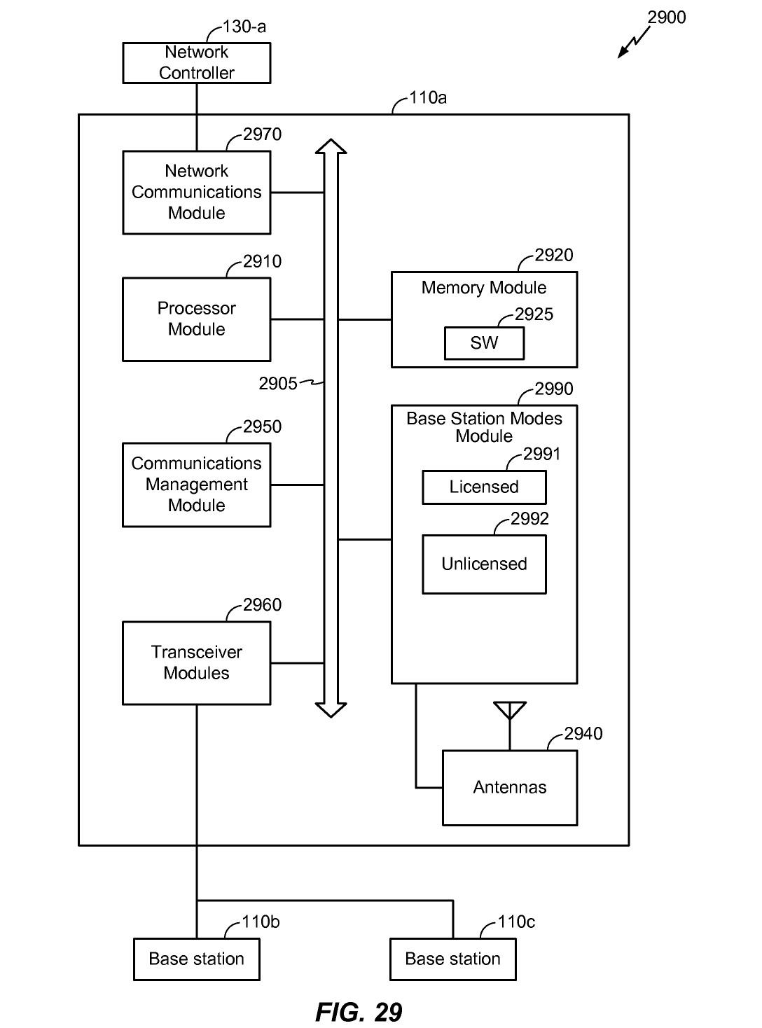

According to certain aspects, means for determining, means for utilizing, means for performing, and means for aligning may comprise a processing system, which may include one or more processors, such as the transmit processor 318, the base station reception processor 338, and/or the base station controller/processor 340 of the base station 300 illustrated in FIG. 3. Additionally, means for determining, means for utilizing, means for performing, and means for aligning may comprise a transmit processor 364, a UE reception processor 358, and/or a UE controller/processor 380 of the user equipment 320. According to certain aspects, means for communicating, may comprise any combination of receivers, transmitters, or transceivers (e.g., the transceiver module 2930 of base station 110a illustrated in FIG. 29 and/or transceiver modules 2840 of the user equipment 120 depicted in FIG. 28).

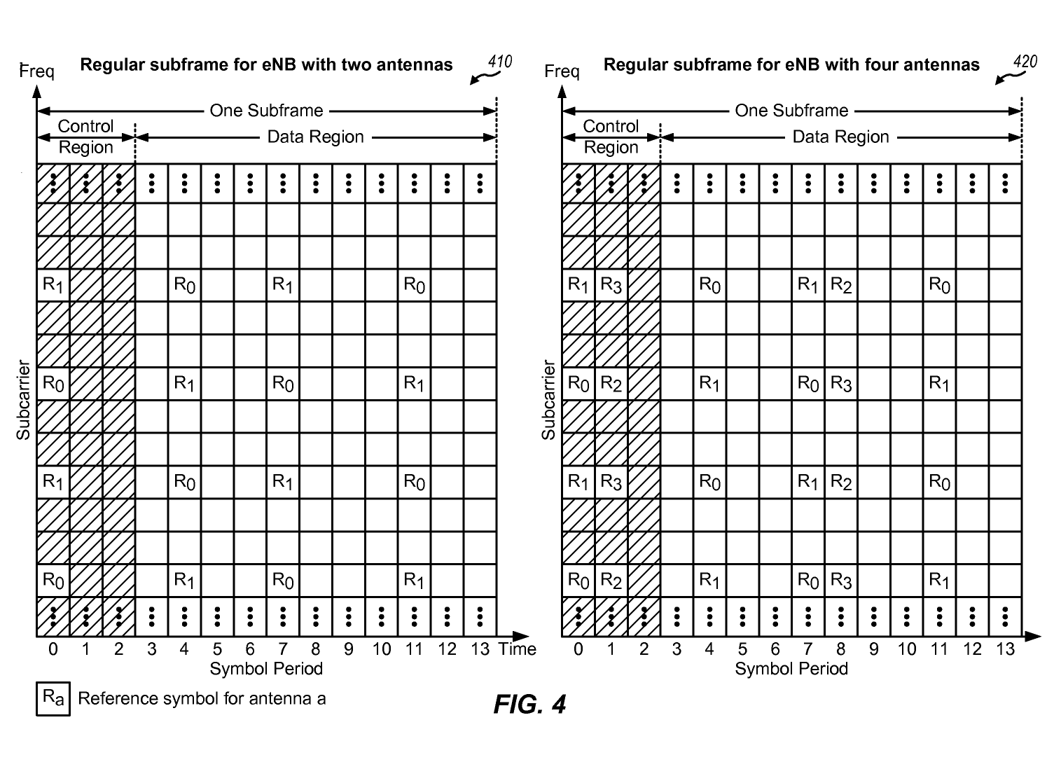

FIG. 4 illustrates various exemplary subframe resource element mapping in accordance with an aspect of the present disclosure. For example, FIG. 4 illustrates two exemplary subframe formats 410 and 420 for the downlink with the normal cyclic prefix. The available time frequency resources for the downlink may be partitioned into resource blocks. Each resource block may include 12 subcarriers in one slot and may include a number of resource elements. Each resource element may correspond to one subcarrier in one symbol period and may be used to send one modulation symbol, which may be a real or complex value.

The subframe format 410 may be used for an eNodeB equipped with two antennas. A common reference signal (CRS) may be transmitted from antennas 0 and 1 in symbol periods 0, 4, 7 and 11. A common reference signal (CRS) is a signal that is known a priori by a transmitter and a receiver and may also be referred to as a pilot signal. A common reference signal (CRS) may be a reference signal that is specific for a cell, e.g., generated based on a cell identity (ID). In FIG. 4, for a given resource element with label Ra, a modulation symbol may be transmitted on that resource element from antenna a, and no modulation symbols may be transmitted on that resource element from other antennas. The subframe format 420 may be used for an eNodeB equipped with four antennas. A common reference signal (CRS) may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. Different eNodeBs may transmit their CRSs on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in a communication network (e.g., LTE network). For example, Q interlaces with indices of 0 through Q−1 may be defined, where Q may be equal to 4, 6, 8, 10, or some other value. Each interlace may include subframes that may be spaced apart by Q subframes. In particular, interlace q may include subframes q, q+Q, q+2Q, etc., where q E (0, 1, . . . , Q−1).

The wireless communication network may support hybrid automatic retransmission (HARQ) for data transmission on the downlink and uplink. For HARQ, a transmitter (e.g., at an eNodeB) may send one or more transmissions of a data packet until the data packet is decoded correctly by a receiver (e.g., at a UE) or some other termination condition is encountered. For synchronous HARQ, all transmissions of the data packet may be sent in subframes of a single interlace. For asynchronous HARQ, each transmission of the data packet may be sent in any subframe.

A UE may be located within the geographic coverage area of multiple eNodeBs. One of the eNodeBs may be selected to serve the UE and may be called “serving eNodeB,” while other eNodeB(s) may be called “neighboring eNodeB(s).” The serving eNodeB may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more neighboring eNodeBs.

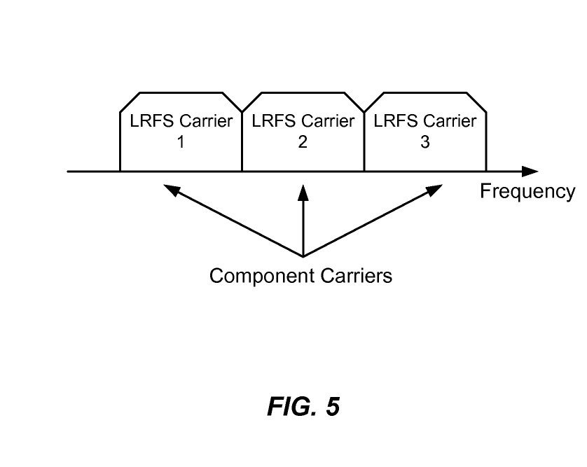

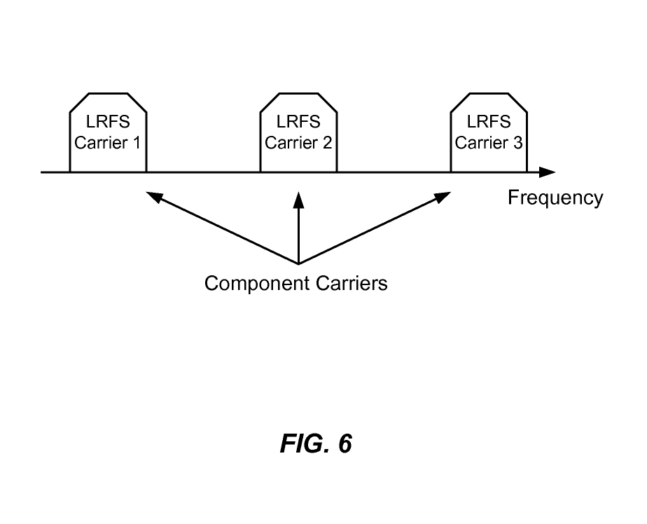

UEs (e.g., LTE-Advanced enabled UEs) may use spectrum of up to 20 MHz bandwidths per carrier allocated in a carrier aggregation of up to a total of 100 MHz (e.g., with 5 carriers, with each aggregated carrier referred to as a component carrier) used for transmission and reception. A component carrier may have a known bandwidth, for example, of 1. 4, 3, 5, 10, 15 or 20 MHz. In some cases, a maximum of five component carriers may be aggregated, resulting in a maximum aggregated bandwidth of 100 MHz assuming a 20 MHz bandwidth per component carrier. For the LTE-Advanced enabled wireless communication systems, two types of carrier aggregation (CA) methods have been proposed: contiguous CA and non-contiguous CA, which are illustrated in FIGS. 5 and 6, respectively.

As illustrated in FIG. 5, contiguous CA may involve the use of multiple available component carriers that are adjacent to each other. On the other hand, as illustrated in FIG. 6, non-contiguous CA may involve the use of multiple non-adjacent available component carriers that are separated along a frequency band.

According to certain aspects, both non-contiguous and contiguous CA may aggregate multiple component carriers to serve a single unit of certain UEs, such as LTE-Advanced (LTE-A) UEs that use LRFS bands. In various examples, the UE operating in a multicarrier system (also referred to as carrier aggregation) may be configured to aggregate certain functions of multiple carriers, such as control and feedback functions, on the same carrier, referred to as a “primary component carrier” (PCC) or “primary carrier.” The remaining carriers that depend on the primary carrier for support may be referred to as “secondary component carriers” (SCC) or “associated secondary carriers.” For example, the UE may aggregate control functions such as those provided by an optional dedicated channel (DCH), nonscheduled grants, a physical uplink control channel (PUCCH), and/or a physical downlink control channel (PDCCH).

As noted above, various mechanisms utilizing a URFS band have been explored to provide additional bandwidth and enhance capacity in wireless systems. For example, implementing long term evolution (LTE) in a URFS band has been considered to alleviate spectrum congestion problems for future wireless needs. The URFS band design may be based on synchronous operation among different public land mobile networks (PLMNs), which allows for listen before talk (LBT)/clear channel assessment (CCA) design to coordinate across PLMNs. Synchronous operation may also simplify design and management. However, in practical deployments, different operators may have different system timing. For frequency division multiplexing (FDM), for example, there may be no direct incentive for the operators to align timing.

As used herein, the term synchronous may refer to the scenario where boundaries of frames transmitted using component carriers are aligned. On the other hand, the term asynchronous may refer to the scenario where boundaries of frames transmitted using component carriers are not aligned and are offset by some time shift. In some cases, frame boundaries may not be aligned, while subframe boundaries may be aligned (e.g., the time shift may be some multiple of subframes). Aspects of the present disclosure address various scenarios where frames transmitted using certain component carriers, in LRFS and/or URFS bands, are asynchronous.

In general, for URFS band operation, it may be desirable to have synchronized operation among different PLMNs for both LRFS and URFS bands. When the operations of different PLMNs are not synchronized in the URFS band, various asynchronous communication options may exist. For example, a different channel/frequency may be chosen among different operators, which is possible when the network is not very congested. However, if the network is already congested and different operators have to work within the same channel, it may be desirable to have URFS band operation synchronized, and manage the different timing offsets between the LRFS band primary cell (Pcell) and the URFS band secondary cell (Scell) in supplemental downlink (SDL) and CA. For stand alone (SA) mode, there may be less issues since URFS band operation may rely on CCA exempt transmissions (CETs) to maintain synchronization for the URFS band operation. Another asynchronous communication option may be to maintain synchronous operation between operators in the URFS band and to allow asynchronous operation between the LRFS band and URFS band carriers. Yet another asynchronous communication option may be to adjust the duration of the CCA window, which may be desirable if an operator is consistently blocked for transmission by another operator.

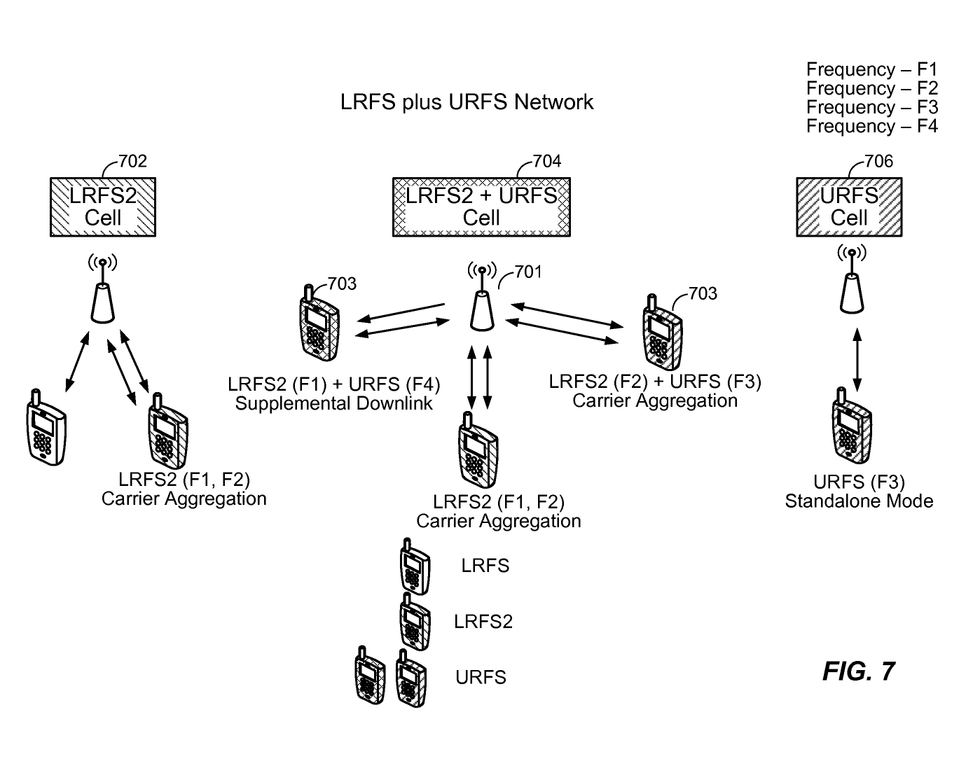

FIG. 7 illustrates different deployment scenarios, in accordance with certain aspects of the disclosure. For example, FIG. 7 illustrates an example deployment with a cell 702 using an LRFS band LRFS2 (e.g., LTE-Advanced) cell and a deployment with a cell 704 using both LRFS band and URFS band operation, and a deployment with a cell 706 using URFS band operation. In cell 704 using both LRFS band and URFS band operation, an eNB 701 and UE 703 may operate in both LRFS and/or URFS bands.

According to certain aspects, the eNB and UE may utilize a URFS band in various manners, for example, including an SDL mode in which downlink capacity in the LRFS band (e.g., LTE) may be offloaded to the URFS band, a carrier aggregation (CA) mode in which both LTE downlink and uplink capacity may be offloaded from the LRFS band to the URFS band, and a stand alone (SA) mode in which downlink and uplink communications between a base station (e.g., eNB) and a UE may take place in the URFS band. Each of these different modes may operate according to frequency division duplexing (FDD) or time division duplexing (TDD).

According to certain aspects, OFDMA communications signals may be used in the communications links for downlink transmissions in LRFS and/or URFS bands, while SC-FDMA communications signals may be used in the communications links for uplink transmissions in LRFS and/or URFS bands.

According to certain aspects, transmissions using the URFS band may be carried using one or more carrier frequencies in a frequency band. A frequency band, for example, may be divided into multiple carrier frequencies, and each carrier frequency may have the same bandwidth or different bandwidth. For example, each carrier frequency may occupy 20 MHz of a 5 GHz frequency band.

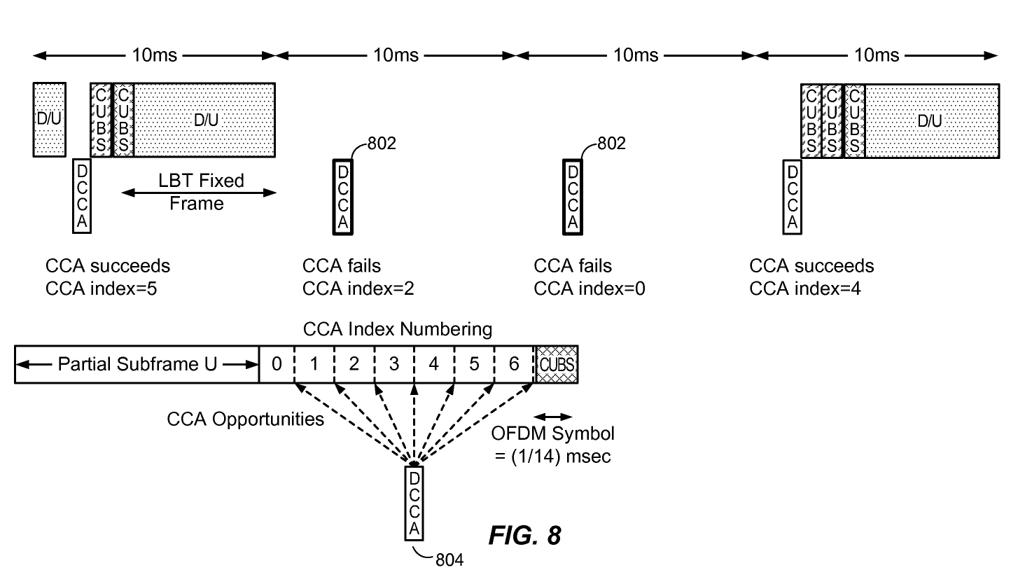

FIG. 8 illustrates an example of synchronous operation of the URFS band using CCA, in accordance with certain aspects of the disclosure. Synchronized operation may be used to manage URFS band resources among operators. Synchronized operation may be achieved, for example, through the use of LBT/CCA 802. According to certain aspects, CCA reuse may allow for coordination among different operators (e.g., by having a reuse factor of 7 with 7 CCA opportunities as shown in FIG. 8 at 804). The CCA location or CCA index numbering for an operator may be randomized over time to maintain fairness among operators.

For an operator, there may be many reasons to maintain a synchronized network. For example, an operator may want to maintain a synchronized network for TDD system operation, for further Enhanced Inter-cell Interference Coordination (eICIC), or for coordinated multipoint (CoMP). Three techniques may be used to align system timing for an operator, which may include global positioning system (GPS), IEEE 1588 v2, and network listening. Synchronization across different operators and across different frequency spectrum bands may not be required. However, if different operators are synchronized through the same source, for example GPS, it is possible that their subframe boundary may be roughly aligned, though the frame boundary may still be misaligned.

In an example, different operators of the URFS band may have different system timing. Thus, there may be a need to design and manage the URFS band for operators having asynchronous system timing deployment.

As discussed above, several deployment scenarios for a system using an asynchronous URFS band may include supplemental downlink (SDL), carrier aggregation (CA), and standalone (SA) mode designs.

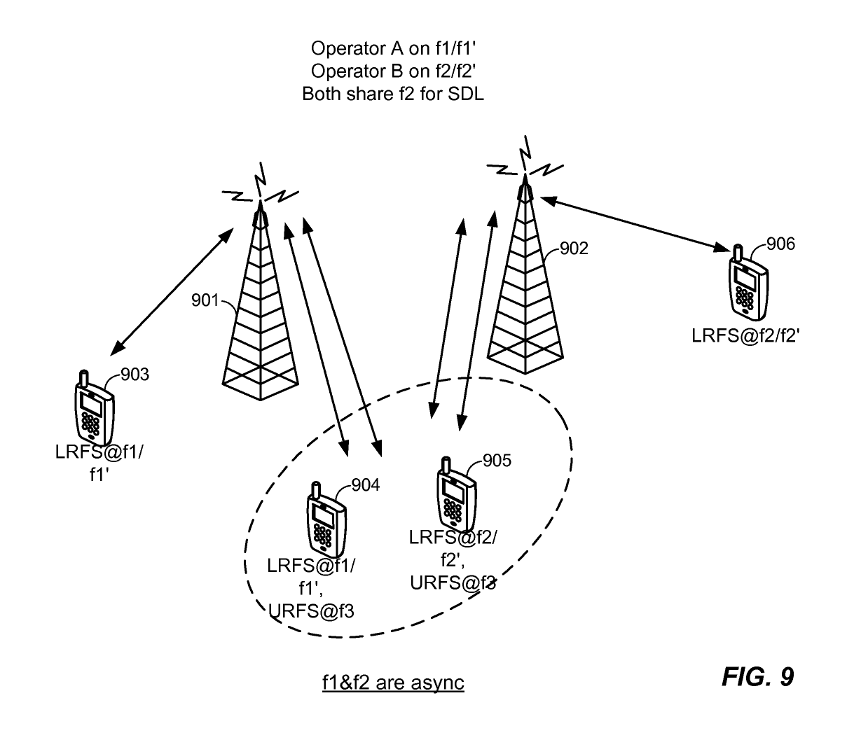

FIG. 9 shows an example asynchronous deployment of two operators on a URFS band, in accordance with certain aspects of the disclosure. In accordance with certain aspects of the disclosure, base stations (BS) 901 and 902 may communicate with various UEs on both LRFS and URFS bands. For example, BS 901 may communicate with UE 903 on the LRFS band at frequencies f1/f1′. Similarly, BS 902 may communicate with UE 906 on the LRFS band at frequencies f2/f2′. As depicted in FIG. 9, frequencies f1 and f2 may be asynchronous with each other. Additionally, BS 901 may communicate with UE 904 on the LRFS band at frequencies f1/f1′ and on the URFS band at frequency f3. Likewise, BS 902 may communicate with UE 905 on the LRFS band at frequencies f2/f2′ and on the URFS band at frequency f3.

Referring to FIG. 9, under an SDL deployment scenario, an operator A may operate at f1/f1′, and an operator B may operate at f2/f2′, both using FDD. According to certain aspects, operators A and B may not be synchronized in the LRFS band. According to an aspect of the present disclosure, certain SDL may be supported with synchronized timing in the URFS band at frequency f3, which operators A and B may share, as depicted in FIG. 9.

As noted above, under a CA deployment scenario, operator A may operate at frequencies f1/f1′, operator B may operate at frequencies f2/f2′, both using FDD. However, operators A and B may not be synchronized in the LRFS band. According to certain aspects, CA may be supported in TDD for both DL and UL on the URFS band at frequency f3.

According to certain aspects, for a standalone (SA) deployment scenario (not shown in FIG. 9), operator A may operate at f3 and operator B may also operate at f3. Both operators A and B may use TDD for both DL and UL in URFS band f3. Under SDL and CA, there may be two deployment scenarios, which may include a homogeneous network with different Macro cells (sites) from different operators and a heterogeneous network (HetNet) with small cells within a coverage area of a Macro site. SA may be considered to have homogeneous small cells.

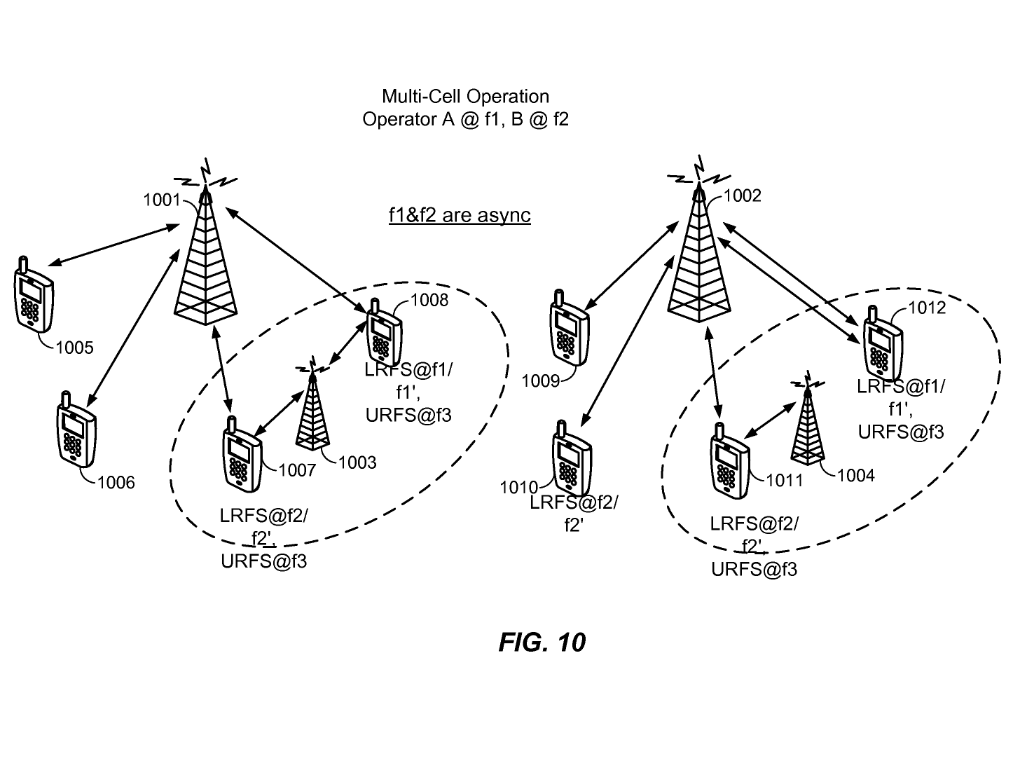

FIG. 10 illustrates multi-cell operation with an asynchronous URFS band deployment, in accordance with certain aspects of the disclosure. According to certain aspects, BS 1001 (e.g., of a macro cell) may communicate with UE 1008 on the LRFS band at frequency f1/f1′. BS 1003 may create a relatively small cell (e.g., a femto cell or pico cell) and may also communicate with UE 1008 on the URFS band at frequency f3. Additionally, BS 1001 may communicate with UE 1007 on the LRFS band at frequency f2/f2′, and BS 1003 may also communicate with UE 1007 on the URFS band at frequency f3. Further, BS 1002 may communicate with UE 1011 on the LRFS band at frequency f2/f2′, and BS 1004 (e.g., of a small cell) may communicate with UE 1011 on the URFS band at frequency f3. Finally, BS 1002 may communicate with UE 1012 both on LRFS and URFS bands at frequencies f1/f1′ and f3, respectively.

According to certain aspects, there may be several deployment solutions for an asynchronous URFS band network. These deployment solutions may include using FDM through channel selection for different operators; maintaining asynchronous operation between different operators in the URFS band, while each operator may have operations in the URFS band synchronized with its operations in the LRFS band; maintaining synchronous operations between operators in the URFS band, while each operator may have operations in the URFS band asynchronous with its operations in the LRFS band; or using a smaller CCA timing to keep operations of different operators in the URFS band synchronized when the different operators are synchronized in the LRFS band (e.g., to the 1 ms level).

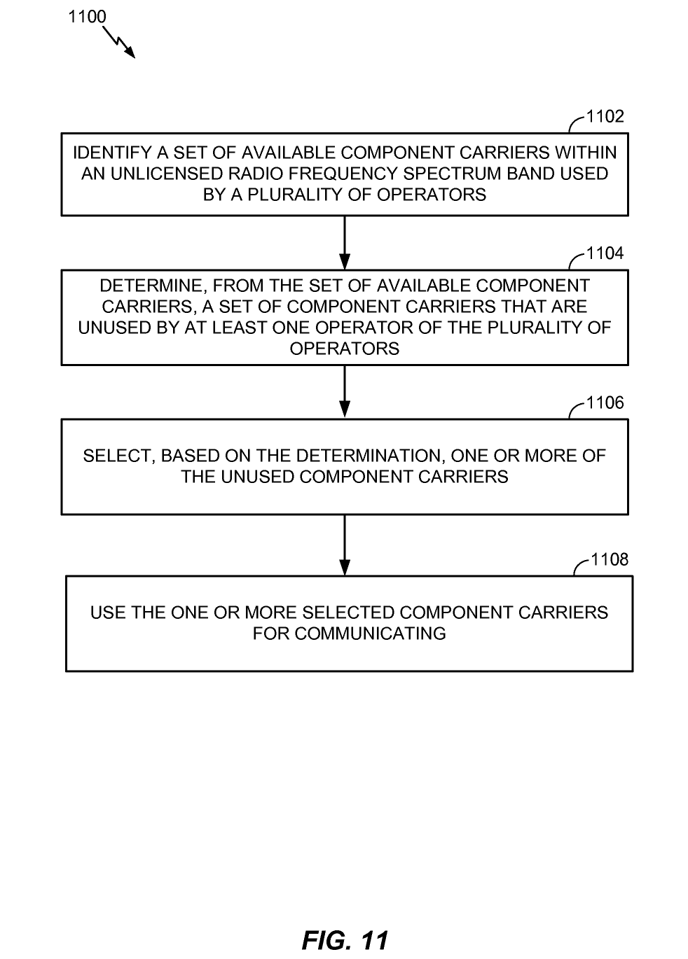

FIG. 11 illustrates example operations 1100 for communicating using component carriers in a URFS band, in accordance with certain aspects of the disclosure. The operations 1100 may be performed, for example, by a wireless device (e.g., eNB 110a and/or UEs 120 and 320) to select component carriers to use for communicating using a URFS band.

The operations 1100 begin, at 1102, by identifying a set of available component carriers within an unlicensed radio frequency spectrum band used by a plurality of operators. At 1104, the wireless device determines, from the set of available component carriers, a set of component carriers that are unused by at least one operator of the plurality of operators. At 1106, based on the determination, the wireless device selects one or more of the unused component carriers. At 1108, the wireless device uses the one or more selected component carriers for communicating.

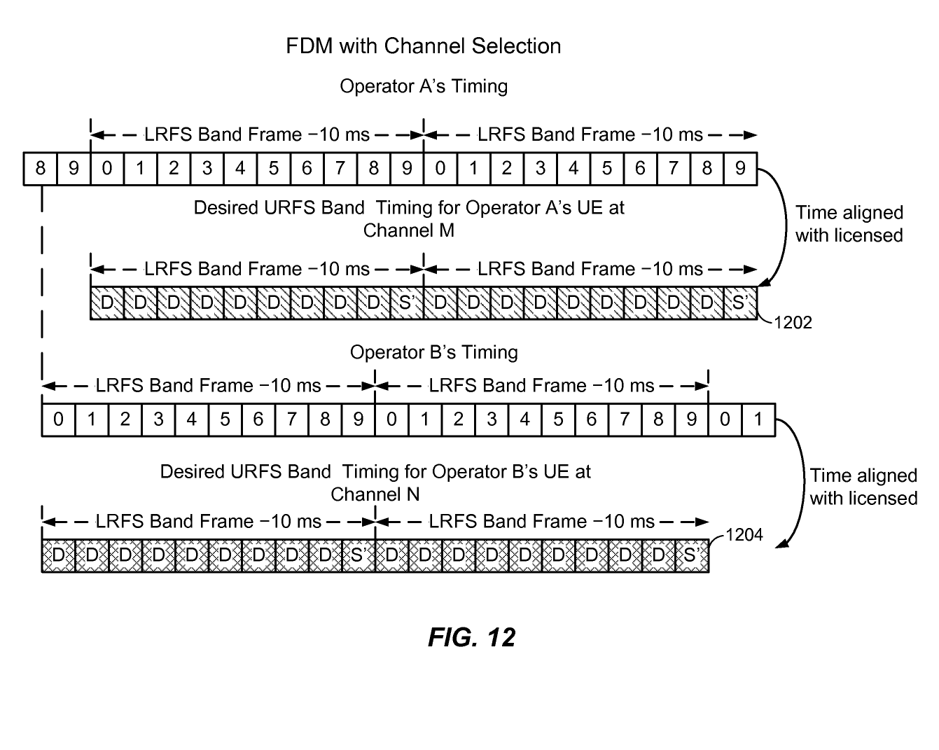

FIG. 12 illustrates an example of a system with different operators (e.g., operators A and B) communicating using different component carriers in a URFS band. According to certain aspects (e.g., in accordance with operations 1100 described above), operators A and B may utilize FDM with channel selection. For example, Operator A may communicate in the URFS band using component carriers (e.g., 1202) at a particular frequency or channel (e.g., channel M). Likewise, Operator B may communicate in the URFS band using component carriers (e.g., 1204) at a particular frequency or channel (e.g., channel N) different from Operator A. Under this approach, channel selection may be used in the URFS band to avoid interferences between operators. Such channel selection may be used to adapt to loading on the network. Additionally, channel selection may not require different operators to operate in synch with each other.

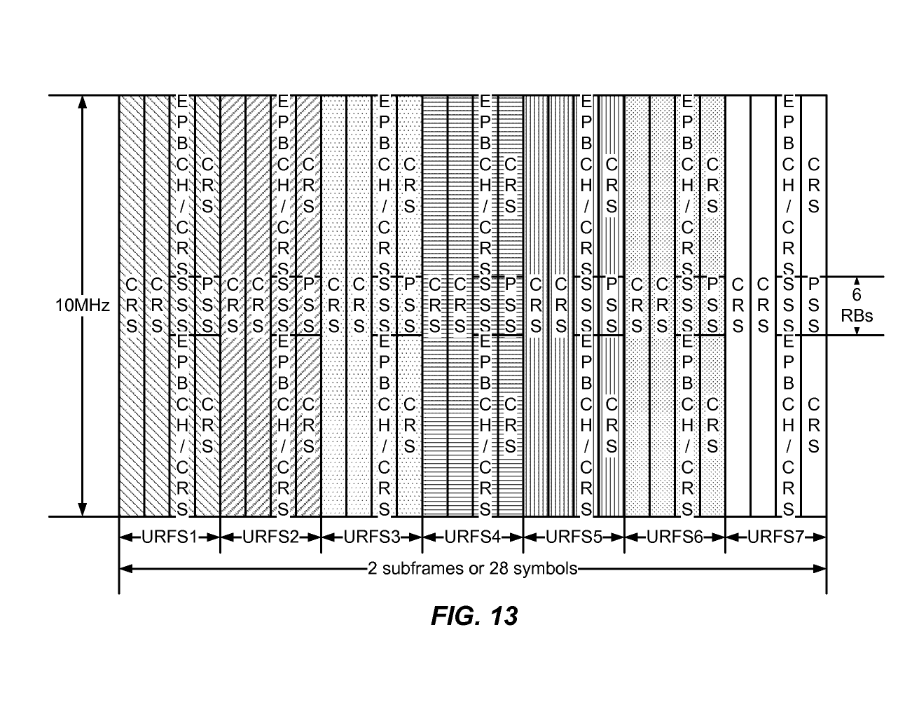

FIG. 13 illustrates an example channel layout 1300, in accordance with certain aspects of the disclosure. Frequency domain separation may be the one of many approaches to solve asynchronous URFS band deployment issues. This approach may be supported by 10 MHz bandwidth design for URFS band operation. A 10 MHz bandwidth design may allow for better multiplexing between URFS band operators. Illustratively, the design allows for time multiplexing across 2 subframes, or 28 (2×14) symbols, allowing for 4 symbols each of 7 different partitions (labeled as URFS1 . . . URFS7). The PHY channel design may be revised to enable the frequency domain separation approach, such as the code rate for ePBCH structure shown in FIG. 13.

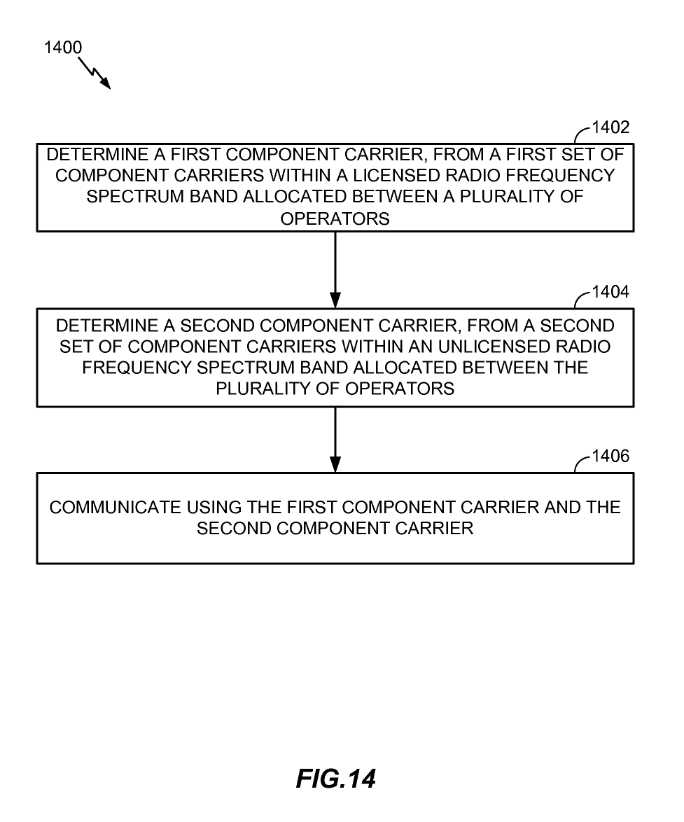

FIG. 14 illustrates example operations for communicating using component carriers in LRFS and URFS bands, in accordance with certain aspects of the disclosure. The operations 1400 may be performed by a wireless device (e.g., eNB 110a and/or UEs 120 and 320) to communicate using component carriers within an LRFS band and component carriers within a URFS band.

Operations 1400 begin at 1402 by determining a first component carrier, from a first set of component carriers within a licensed radio frequency spectrum allocated between a plurality of operators. At 1404, a second component carrier may be determined from a second set of component carriers within an unlicensed radio frequency spectrum band allocated between the plurality of operators. At 1406, the first component carrier and the second component carrier may be used for communication.

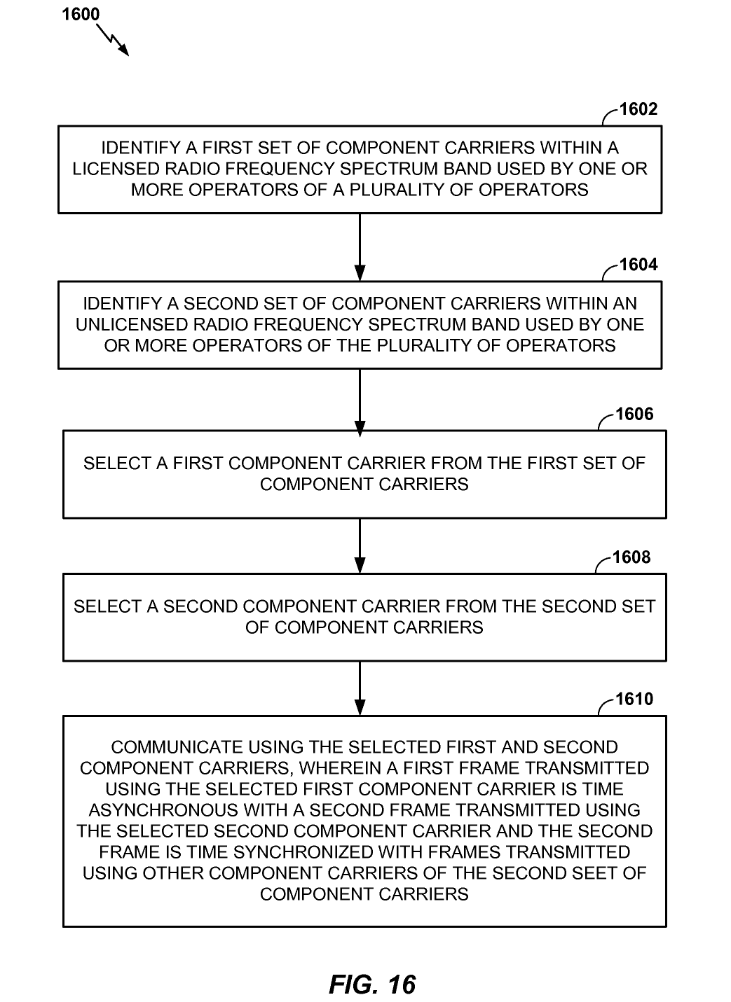

Frames transmitted using the component carriers (determined in 1402 and 1404) may be time synchronized (i.e., time aligned) in various manners. For example, a first frame transmitted using the first component carrier and a second frame transmitted using the second component carrier may be time synchronized, while the second frame may be time asynchronous (i.e., not time aligned) with frames transmitted using other component carriers of the second set of component carriers. As another example (described in more detail below with respect to FIG. 16), a first frame transmitted using the first component carrier (an LRFS band component carrier) may be time asynchronous with a second frame transmitted using the second component carrier (a URFS band component carrier) and the second frame is time synchronized with frames transmitted using other component carriers of the second set of component carriers.

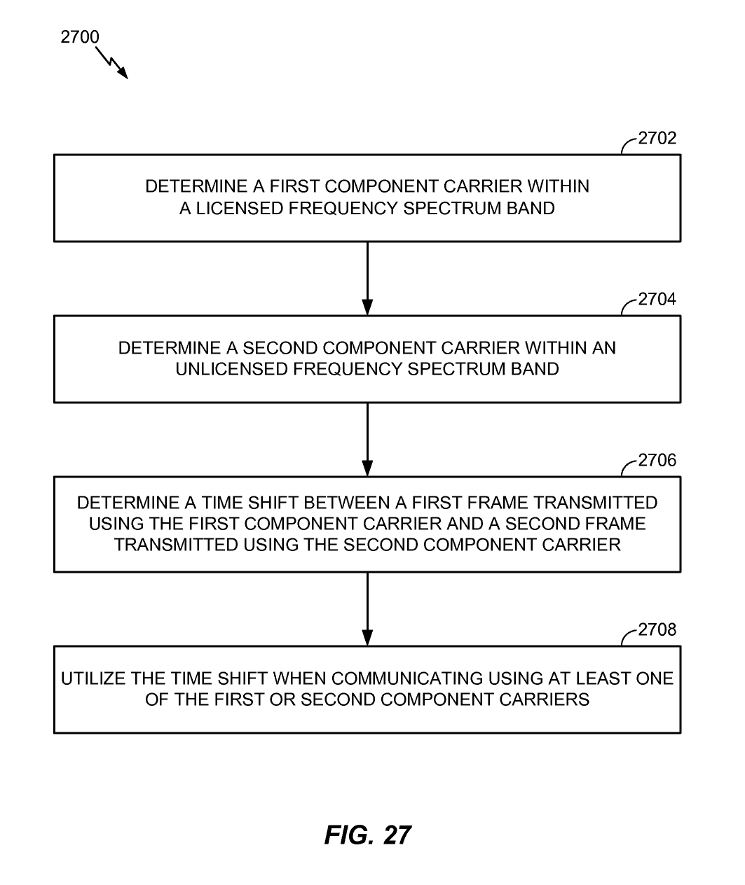

According to certain aspects, and described in more detain herein with respect to FIG. 27, the operations 1400 may comprise determining a time shift between frames to be communicated using component carriers on LRFS and URFS bands and using the time shift when communicating using at least one of the LRFS or URFS bands.

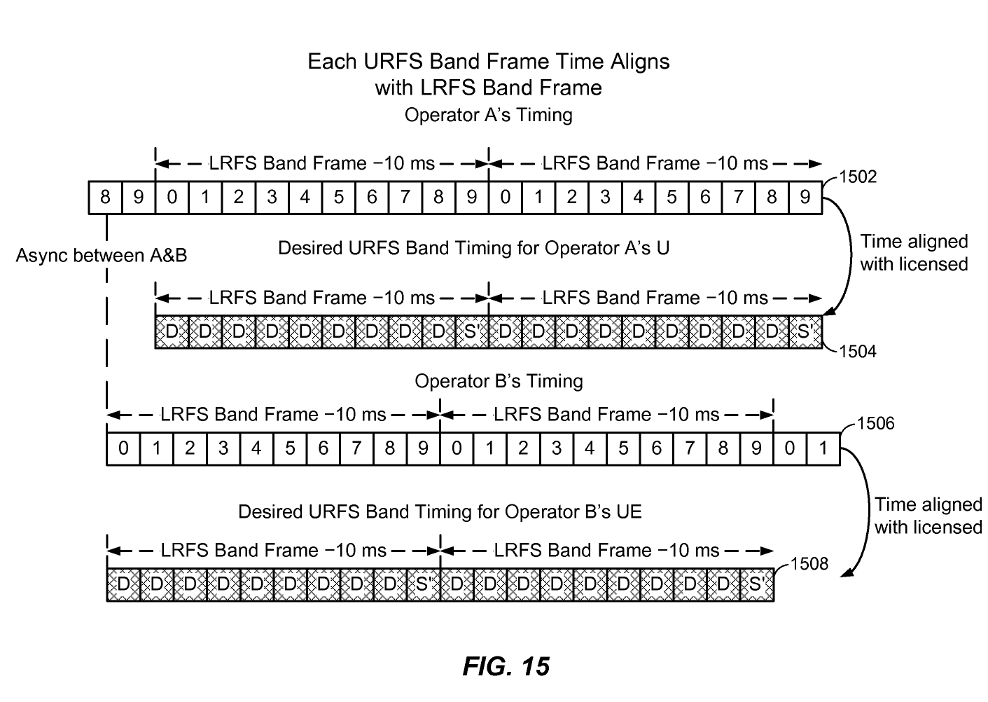

FIG. 15 illustrates an example system with frames 1504 transmitted using a component carrier in the URFS band aligned with frames 1502 transmitted using a component carrier in the LRFS band, in accordance with certain aspects of the disclosure. The example illustrates another approach that may be used to solve asynchronous URFS band deployment issues: maintaining asynchronous operation between operators in spectrum URFS band, by misaligning the frames transmitted by the different operators in the URFS band, while having frames transmitted by each operator time synchronized with its own frames transmitted in the LRFS band. For example, as illustrated in FIG. 15, the timing of the URFS band frames 1504 of Operator A is synchronized with the timing of the LRFS band frames 1502 of Operator A. Likewise, the timing of the URFS band frames 1508 of Operator B is synchronized with the timing of the LRFS band frames 1506 of Operator B. However, as can been seen, the timing of the URFS band frames 1504 of Operator A are asynchronous with the timing of URFS band frames 1508 of Operator B. Under this approach, both operators may be able to coexist at low load levels, otherwise one operator may be forced to select another channel.

As noted above, FIG. 16 illustrates example operations 1600 for determining first and second component carriers, in accordance with aspects of the present disclosure. The operations 1600 may be considered corresponding to operations 1402 and 1404 when communicating using component carriers in LRFS and URFS bands in which component carriers in the LRFS band are not time aligned with component carriers in the URFS band, while component carriers in URFS bands are time aligned with each other.

The operations 1600 may be performed, for example, by a wireless device e.g., eNB 110a and/or UEs 120 and 320) to communicate with frames transmitted by different operators using different component carriers within a URFS band that are aligned with each other (e.g., time synchronous), while a frame transmitted by an operator in an LRFS band is misaligned (e.g., time asynchronous) with a frame transmitted by the operator in the URFS band.

The operations 1600 begin, at 1602, by identifying a first set of component carriers within a licensed radio frequency spectrum band used by one or more operators of a plurality of operators. At 1604, the wireless device identifies a second set of component carriers within an unlicensed radio frequency spectrum band used by one or more operators of the plurality of operators. At 1606, the wireless device selects a first component carrier from the first set of component carriers. At 1608, the wireless device selects a second component carrier from the second set of component carriers. At 1610, the wireless device communicates using the selected first and second component carriers, wherein a first frame transmitted using the first component carrier is time asynchronous with a second frame transmitted using the second component carrier and the second frame is time synchronized with frames transmitted using other component carriers of the second set of component carriers

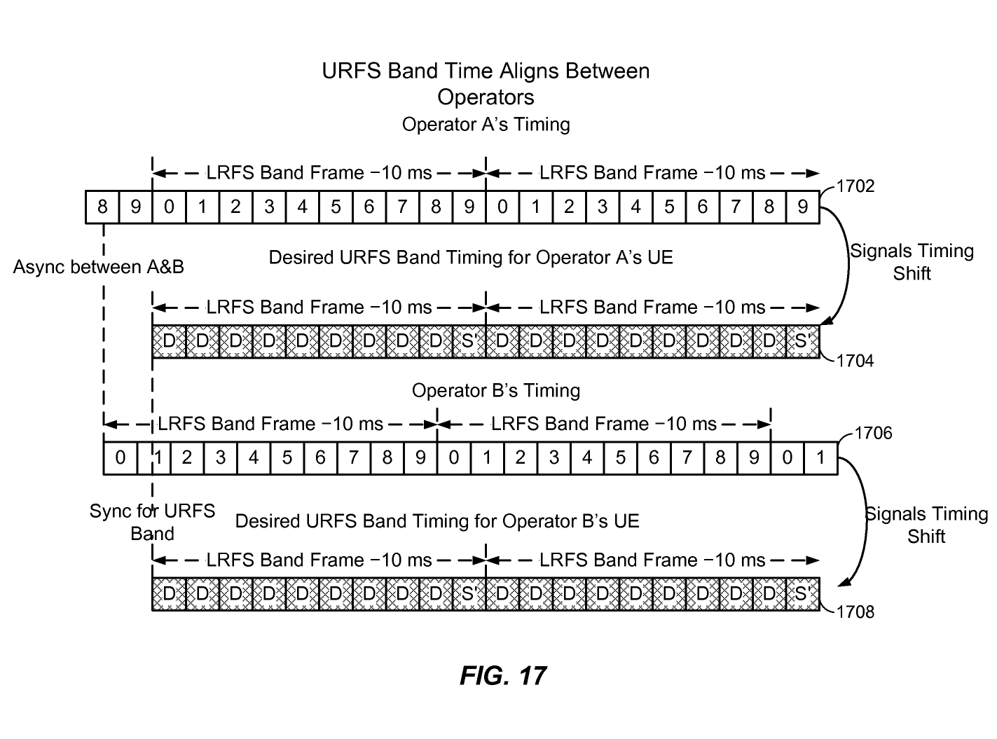

FIG. 17 illustrates an exemplary system with frames transmitted using different component carriers of an unlicensed radio frequency spectrum band aligned in time, in accordance with certain aspects of the disclosure. As can be seen in FIG. 17, time synchronous operation between operators in URFS band may be maintained by aligning frames transmitted by different operators, while a frame transmitted in the URFS band by an operator may be time asynchronous with a frame transmitted by the operator in the LRFS band. For example, as illustrated in FIG. 17, URFS band frames 1704 (e.g., transmitted on a first component carrier in the URFS band) of Operator A may be time asynchronous with LRFS band frames 1702 (e.g., transmitted on a first component carrier in the LRFS band) of Operator A while time synchronized to the URFS band frames 1708 (e.g., transmitted on a second component carrier in the URFS band) of Operator B. Likewise, URFS band frames 1708 (e.g., transmitted on a second component carrier in the URFS band) of Operator B may be time asynchronous with LRFS band frames 1706 (e.g., transmitted on a second component carrier in the LRFS band) of Operator B while time synchronized to the URFS band frames 1704 (e.g., transmitted on a first component carrier in the URFS band) of Operator A.

As discussed above, one approach to solving URFS band deployment issues is to have different timing (e.g., time asynchronous operation) frame transmission between LRFS and URFS bands of an operator. This approach may be implemented for SDL mode and/or CA mode.

Under an asynchronous LRFS/URFS band approach, one or more timing shifts between a frame transmitted in the LRFS band and a frame transmitted in the URFS band may be signaled (allowing the timing shift to be applied to effectively align frames).

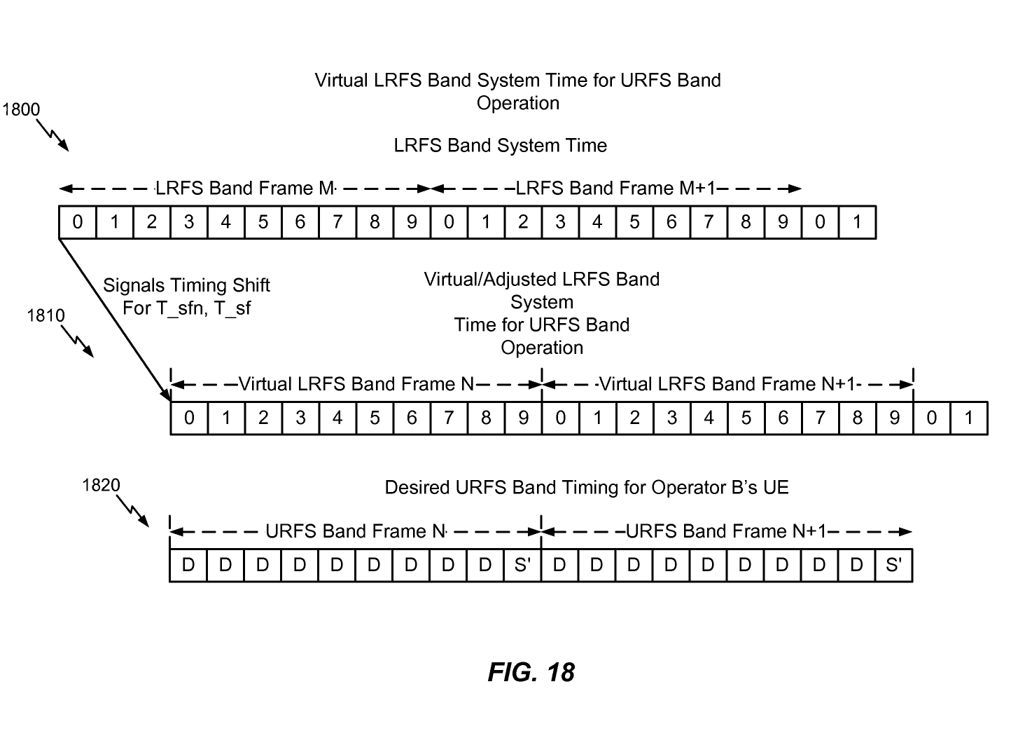

As illustrated in FIG. 18, in some cases, the timing shifts may be greater than a frame duration. In such cases, the one or more timing shifts may include a system frame number (SFN) or radio frame offset on a 10 ms scale, (e.g., shown in FIG. 18 as T_sfn), a subframe offset on 1 ms scale, (e.g., shown in FIG. 18 as T_sf). As illustrated, this information may be used to represent a time shift between LRFS band frames 1800 transmitted in first component carrier and frames 1820 transmitted in a second component carrier (e.g. of an Operator B). As illustrated, the timing shift information may be used to effectively adjust the timing of frames 1800 to generate virtual frames 1810 that are time aligned with frames 1820.

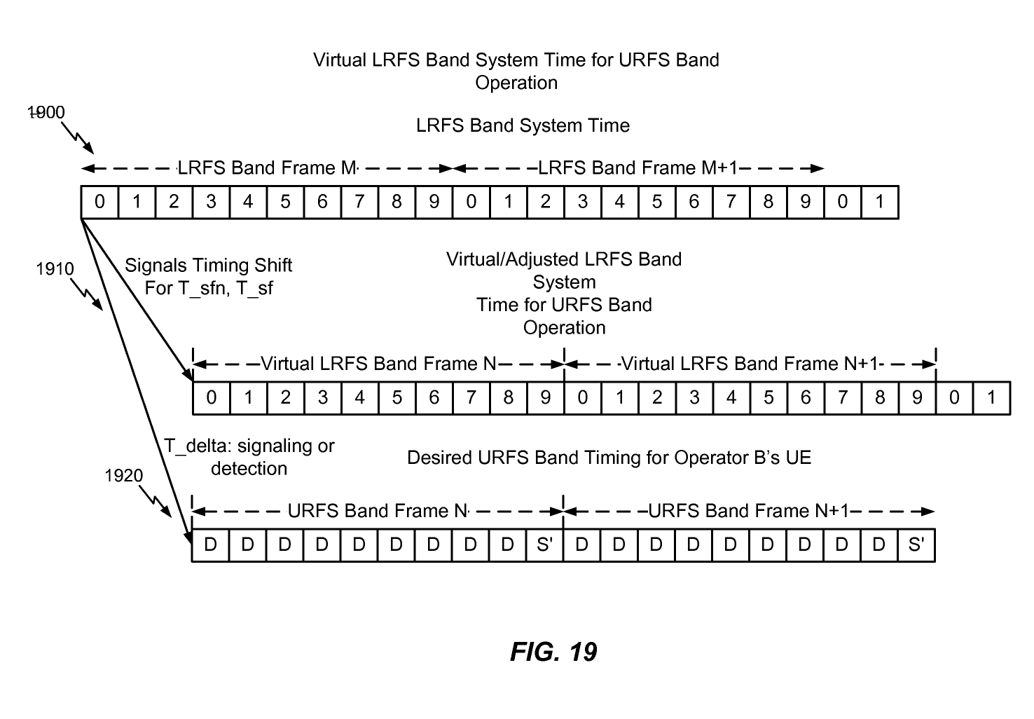

As illustrated in FIG. 19, in some cases, a timing offset of less than 1 ms (e.g., as indicated by T_delta) may also be used to effectively adjust frame timing. As illustrated, the timing shift information (T_sfn, T_sf, and T_delta) may be used to effectively adjust the timing of frames 1900 to generate virtual frames 1910 that are time aligned with frames 1920.

The finer granularity of T_delta may help account for propagation offset. The propagation offset may be due to timing drift or time varying offsets among operators' networks. For example, timing drift or time varying offset among operators' networks may occur because of a change of stratum. A change of stratum may occur because a small cell with lower stratum becomes dormant, so a nearby node listens to a different cell for network synchronization. Additional time drift or time varying offset may also occur because of different network delay using IEEE 588 v2.

The timing shift information may be used to effectively align frames transmitted in a primary cell (Pcell) with frames transmitted in a secondary cell (Scell). For example, the LRFS band of an operator may serve as the Pcell and the URFS band of the operator may serve as the Scell. The Pcell may signal the one or more timing shift for the Scell operation.

The signaling of the timing shift information (e.g., T_sfn, T_sf, and T_delta) may be done in various ways. For example, according to certain aspects, a system information block (SIB) may be broadcasted for signaling the one or more timing shifts of the Scell. The broadcast may include T_sfn (an offset based on a system frame number timing), T_sf (an offset based on a number of subframe durations), and/or T_delta (an offset less than a subframe duration, e.g., 1 ms). According to certain aspects, the UE may search for a CET for new timing in the Scell. The CET may be transmitted in the Scell with the new timing. According to certain aspects, a radio resource control (RRC) signal may include the one or more timing shifts of the Scell. In another option, a Pcell may signal T_sfn and T_sf timing information and a UE may perform an additional search based on CET to determine the propagation timing shift, for example, T_delta.

According to certain aspects, one way to handle time drift may be to use a signaling mechanism whenever timing drift becomes significant. Such signaling may be provided, for example, using a primary control carrier (Pcc), a CET, or RRC signaling. A UE may provide feedback for one or more timing drifts. For example, the UE may need to monitor relative timing of signals for different CETs, or channel usage beacon signals (CUBS), which may allow both timing alignment of CETs as well as relative timing between CET and Pcc.

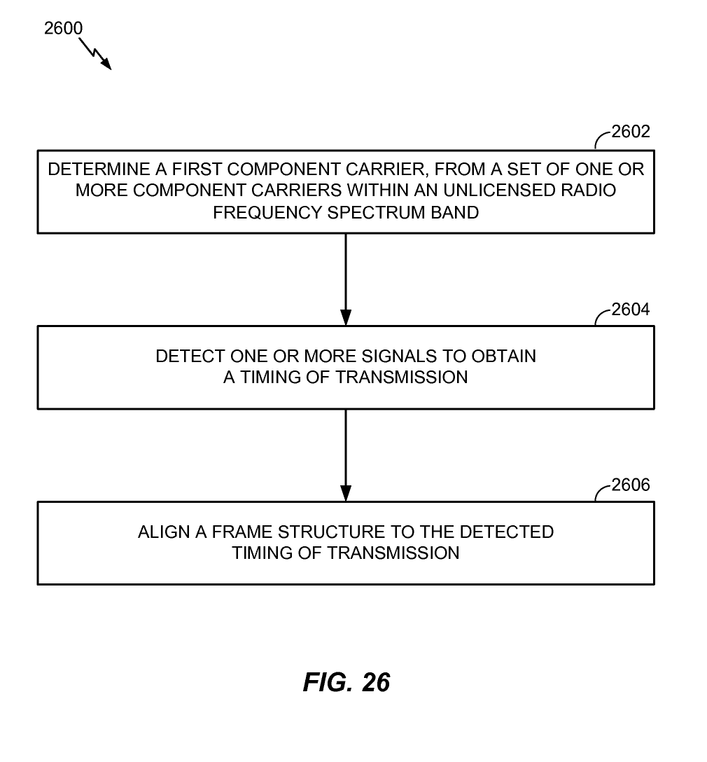

System timing may be used, for example, in impact hoping, sequence, scrambling, search space, demodulation reference signals (DMRSs), and physical uplink control channel (PUCCH) multiplexing. Timing also may impact the paging subframe, the Multicast-broadcast single-frequency network (MBSFN) subframe, etc. FIGS. 26 and 27, below, illustrates example operations for determining time shifts, in accordance with aspects of the present disclosure.

As discussed above, there are different options for reconciling timing for different component carriers (CCs). One example may be to have an LRFS band component carrier follow system timing of the Pcell, T_Pcc, and have a URFS band component carrier follow the system timing of the Scell, T_Scc. Then, a fixed timing shift between T_Pcc and T_Scc may be signaled to UE (e.g., as T_sfn, T_sf, and T_delta). For cross component carrier control, a UE may apply a time shift in order to obtain information from Pcc. According to certain aspects, if a time shift is applied to Scc, the Scc timing should be used.

According to certain aspects, after adjusting the timing shift, both the eNB and the UE may assume a virtual system time (as shown in FIGS. 18 and 19) for the LRFS band system and for the URFS band system's control and HARQ operation.

As noted above, in some cases there may be a relatively small (less than 1 subframe) shift in alignment between frames transmitted on different component carriers, which may impact device operation (e.g., of a UE), depending on which CC is used for signaling control information.

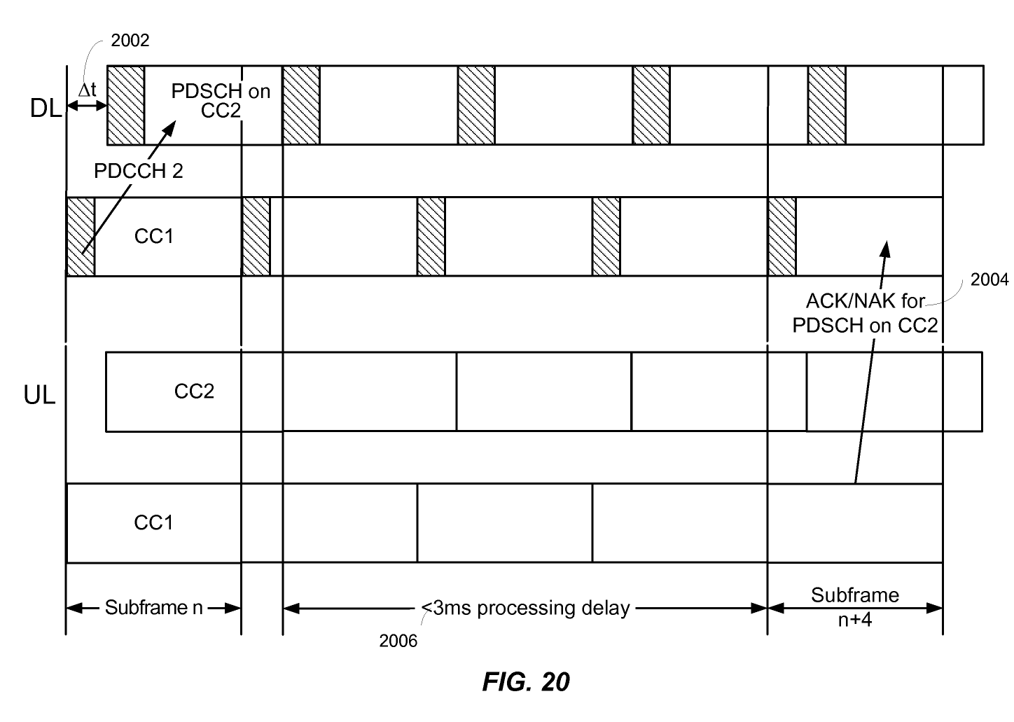

For example, FIG. 20 shows an example for T_delta 2002 in which frame boundaries on a first component carrier (CC1) for a Pcc occur before frame boundaries on a second component carrier (CC2) of a Scc. In this example, UE may receive control information (e.g., PDCCH2) a fraction of a millisecond earlier from the Pcc than Scc. Because the UE gets control earlier, the UE may need to start decoding PDCCH earlier on CC1. However, the corresponding PDSCH (e.g., scheduled by the PDCCH) may arrives later, which effectively reduces the overall time before the UE is to respond with an ACK 2004. The illustrated example assumes the UE sends ACK 2004 on the Pcc (CC1). Because of the shortened duration, a UE may be challenged to meet a 4 ms ACK timing, assuming a common 3 ms processing delay.

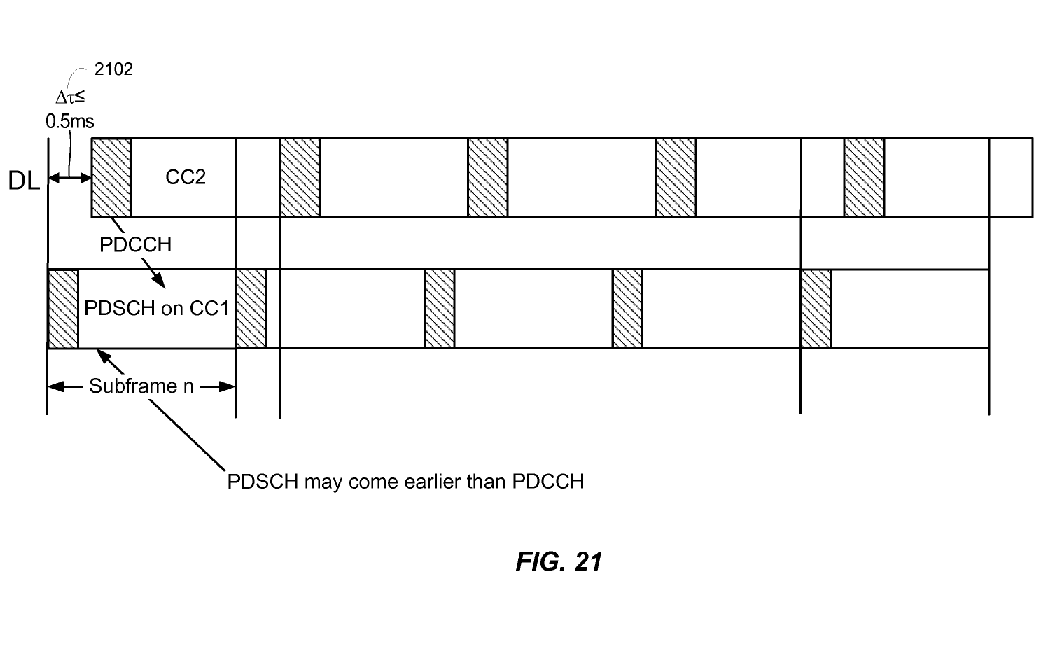

FIG. 21 illustrates an example where the UE may get control a fraction of a millisecond later from the Scc. In this example, PDCCH is provided on CC2 and lags PDSCH (sent on CC1) by T_delta 2102. In this scenario, the UE may buffer data (received via PDSCH) on CC1 earlier and then decodes PDCCH on CC2. As the PDSCH may come earlier than the PDCCH, this option may have a similar timeline issue (as described above) due to the shortened processing time for sending an ACK caused by the late decoding of PDCCH.

For both scenarios shown in FIGS. 20 and 21, there may be a potential delay and impact on the processing time. For the scenario shown in FIG. 20, one way to address this problem may be to define a processing time 2006 of less than 3 ms. For the scenario shown in FIG. 21, one way to address this problem may be to define a new ACK response turnaround time.

According to certain aspects, control signaling may be transmitted on the URFS band (rather than the LRFS band). For the DL, control and data may be transmitted in the same subframe, which may not cause any timing issues. For the UL grant, when the UL grant comes from the URFS band, control signaling carried directly on the URFS band may not be needed as the ACK turnaround time may be not an issue. According to certain aspects, both DL and UL may need to successfully clear CCA to get the grant. With multiple entities transmitting on the same spectrum, there is a probability that the DL may not be able to clear CCA for the grant. Under SDL mode, the UL ACK may need to be sent on the URFS band because a similar issue exists for the time line being less than 3 ms. According to certain aspects, under CA or SA mode, the UL ACK may be sent on the URFS band, which may not cause any timing issue.

According to certain aspects, when the system operation in the LRFS band is time division duplexing (TDD), the system operations in the LRFS band may be time synchronous with system operations in the URFS band. For TDD, there may be several options for channel selection, which include choosing a different frequency channel for URFS band operation (i.e. FDM with 20 MHz (default)), keeping URFS band operation synchronized, and/or enforcing LRFS band carriers to be synchronized across operators.

As noted above, in some cases, component carriers in the URFS band may not be synchronized across different operators. One challenge with this design may be that when operators in the URFS band are not synchronized, depending on relative timing shifts, some operators' signals may always have priority and block other operators' signals (such that they are not able to clear CCA).

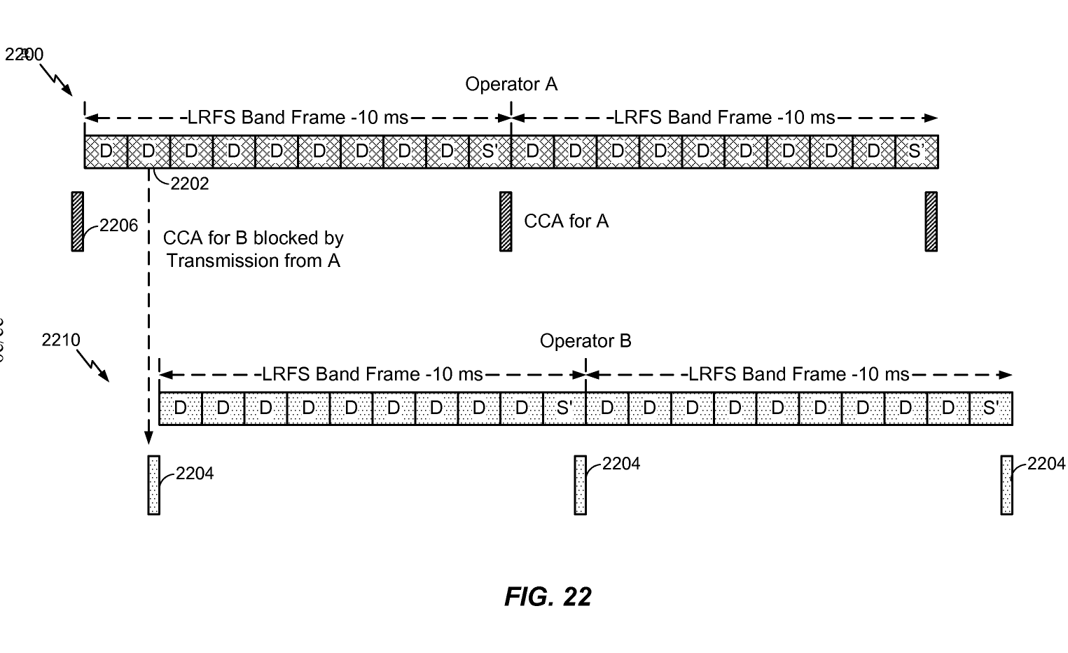

FIG. 22 illustrates how such asynchronous timing between operators may result in CCA being blocked for one or more operators. In the illustrated example, frames 2200 and 2210 of Operators A and B, respectively, are not synchronized. As a result, CCA opportunities 2204 for Operator B fall within transmissions 2202 of Operator A, such that Operator B is not able to clear CCA. As shown, Operator A clears CCA, because Operator B is not transmitting during CCA opportunities 2206 of Operator A.

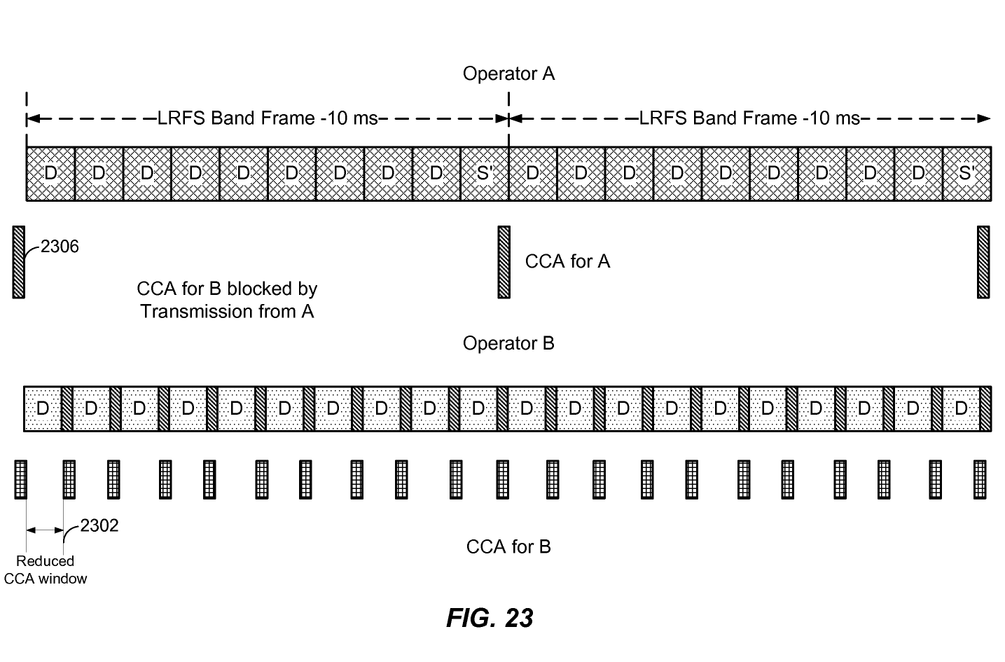

One option to alleviate CCA blocking is to force one of the operators to switch channels. Another option, shown in FIG. 23, is to have one operator use a faster switching time (with more frequent CCA opportunities). In the illustrated example, Operator B has CCA opportunities 2302 that occur more frequently (e.g., with a CCA window of 1-2 ms) than CCA opportunities 2304 of Operator A (shown with a CCA window of 10 ms). As a result, Operator B is much more likely to clear CCA whenever there is a gap in transmissions from Operator A. In some cases, a device may switch to faster switching times if it is consistently blocked (e.g., after consecutive failed attempts to clear CCA).

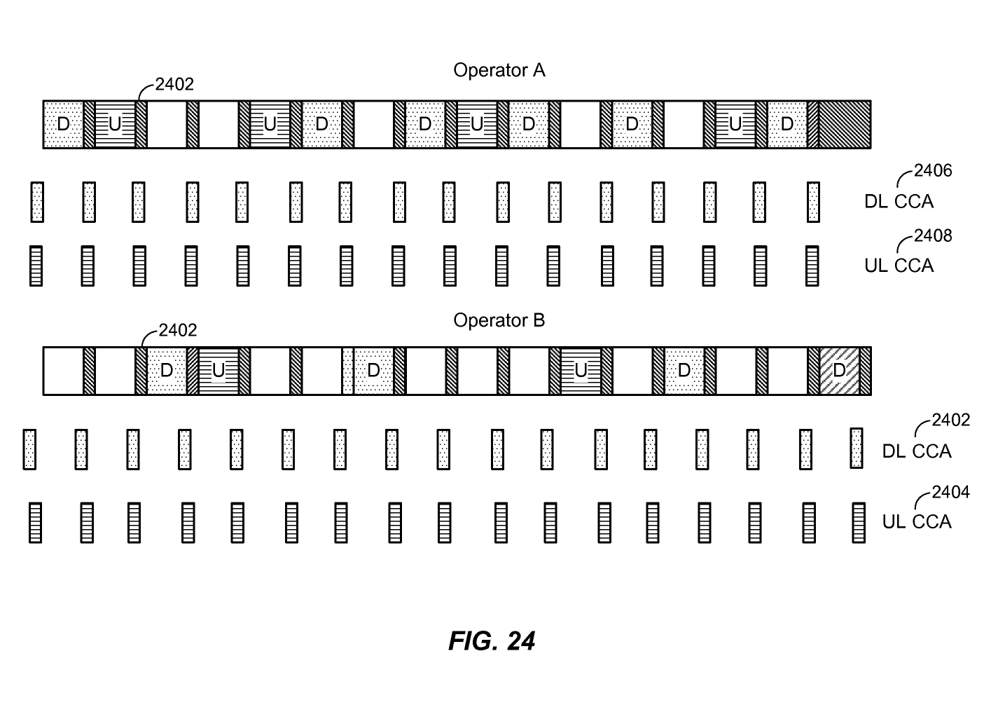

FIG. 24 illustrates another option to address the CCA blocking problem, according to certain aspects of the disclosure. In this example, each operator may use a smaller CCA window. Operating with a smaller CCA window may handle cases where timing is aligned to 1-2 ms boundary, for example, when an eNB is synched to a GPS source. Under this solution, both Operators A and Operator B may be aligned on their CCA opportunities. As illustrated, if both DL and UL transmissions are allowed, then DL and UL CCAs may be also aligned. In the illustrated example, DL CCA opportunities 2402 and UL CCA opportunities 2404 of Operator B are aligned with DL CCA opportunities 2406 and UL CCA opportunities 2404 of Operator B. In some cases, different CCA priority settings may be established for different operators or DL and UL directions (e.g., allowing one operator to transmit even if it fails to clear CCA).

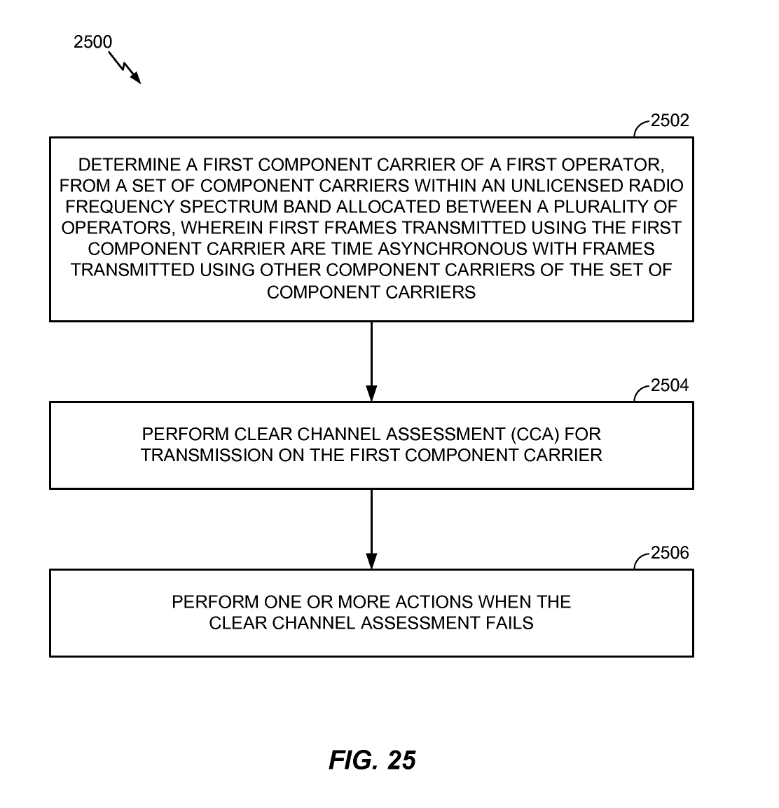

FIG. 25 illustrates example operations 2500 for communicating using component carriers in a URFS band, in accordance with certain aspects of the disclosure. The operations 2500 may be performed by a wireless device (e.g., eNB 110a and/or UEs 120 and 320) to perform CCA in a system utilizing component carriers in URFS bands.

The operations 2500 begin, at 2502, by determining a first component carrier of a first operator, from a set of component carriers within a unlicensed radio frequency spectrum band allocated between a plurality of operators, wherein first frames transmitted using the first component carrier are time asynchronous with frames transmitted using other component carriers of the set of component carriers. The operations 2500 continue, at 2504, by performing clear channel assessment (CCA) for transmission on the first component carrier and by performing one or more actions when the clear channel assessment fails, at 2506. For example, when clear channel assessment fails for a predetermined number of times, a duration of the CCA window may be adjusted (e.g., from a 10 ms to 1-2 ms), as described above with reference to FIGS. 23 and 24.

FIG. 26 illustrates example operations 2600 for communicating using component carriers in frequency URFS band, in accordance with certain aspects of the disclosure. The operations 2600 may be performed, for example, by a UE (e.g., UEs 120 and 320) to align frames transmitted using different asynchronous component carriers.

The operations 2600 begin, at 2602, by determining a first component carrier, from a set of one or more component carriers within an unlicensed radio frequency spectrum band. The operations 2600 continue, at 2604, by detecting one or more signals to obtain a timing of transmission and by aligning a frame structure to the detected timing of transmission, at 2606.

FIG. 27 illustrates example operations 2700 for communicating using component carriers in a URFS band, in accordance with certain aspects of the disclosure. The operations 2700 may be performed, for example, by a base station (e.g., eNB 110a ) to detect time shifts between frames transmitted using different component carriers.

The operations 2700 begin, at 2702, by determining a first component carrier within a licensed radio spectrum band. The operations 2700 continue, at 2704, by determining a second component carrier within an unlicensed radio spectrum band, by determining a time shift between first frames transmitted using the first component carrier and second frames transmitted using the second component carrier, at 2706, and by utilizing the time shift when communicating using at least one of the first or second component carriers, at 2708.

Many of the examples described above have involved SDL or CA scenarios utilizing a combination of carriers in LRFS and URFS bands. In Stand-alone (SA) operation, however, there may be no LRFS band carriers. In SA operation, to maintain synchronized URFS band operation, a first priority may be to choose an unused channel/band (which may be found by attempting CCA on different channels). If all channels/bands are occupied, then an occupied, but less congested, channel may be chosen. According to certain aspects, a search for existing CETS transmission from other operators may be completed, and timing to the existing CETS may be aligned.

FIG. 28 illustrates a UE 120 configured for URFS band operation. The UE 120 may include or be part of a personal computer (e.g., laptop computer, netbook computer, tablet computer, etc.), a cellular telephone, a PDA, a digital video recorder (DVR), an internet appliance, a gaming console, an e-readers, etc. The UE 120 may have an internal power supply (not shown), such as a small battery, to facilitate mobile operation. The UE 120 may be configured to implement at least some of the features and functions described above with respect to FIGs. described above.

The UE 120 may include a processor module 2810, a memory module 2820, a transceiver module 2840, antennas 2850, and an UE modes module 2860. Each of these components may be in communication with each other, directly or indirectly, over one or more buses 2805.

The memory module 2820 may include random access memory (RAM) and read-only memory (ROM). The memory module 2820 may store computer-readable, computer-executable software (SW) code 2825 containing instructions that are configured to, when executed, cause the processor module 2810 to perform various functions described herein for using LTE-based communications in a URFS band. Alternatively, the software code 2825 may not be directly executable by the processor module 2810 but be configured to cause the computer (e.g., when compiled and executed) to perform functions described herein.

The processor module 2810 may include an intelligent hardware device, e.g., a central processing unit (CPU), a microcontroller, an application-specific integrated circuit (ASIC), etc. The processor module 2810 may process information received through the transceiver module 2840 and/or to be sent to the transceiver module 2840 for transmission through the antennas 2850. The processor module 2810 may handle, alone or in connection with the UE modes module 2860, various aspects of using LRFS-band-based communications in a URFS band.

The transceiver module 2840 may be configured to communicate bi-directionally with base stations (e.g., base stations 110). The transceiver module 2840 may be implemented as one or more transmitter modules and one or more separate receiver modules. The transceiver module 2840 may support communications in an LRFS band (e.g., LTE) and in a URFS band. The transceiver module 2840 may include a modem configured to modulate the packets and provide the modulated packets to the antennas 2850 for transmission, and to demodulate packets received from the antennas 2850. While the UE 120 may include a single antenna, there may be embodiments in which the UE 120 may include multiple antennas 2850.

According to the architecture of FIG. 28, the UE 120 may further include a communications management module 2830. The communications management module 2830 may manage communications with various access points. The communications management module 2830 may be a component of the UE 120 in communication with some or all of the other components of the UE 120 over the one or more buses 2805. Alternatively, functionality of the communications management module 2830 may be implemented as a component of the transceiver module 2840, as a computer program product, and/or as one or more controller elements of the processor module 2810.

The UE modes module 2860 may be configured to perform and/or control some or all of the functions or aspects described above related to using LRFS-band-based communications in a URFS band. For example, the UE modes module 2860 may be configured to support a supplemental downlink mode, a carrier aggregation mode, and/or a standalone mode. The UE modes module 2860 may include a Licensed module 2861 configured to handle LRFS band communications and an Unlicensed module 2862 configured to handle URFS band communications. The UE modes module 2860, or portions of it, may be a processor. Moreover, some or all of the functionality of the UE modes module 2860 may be performed by the processor module 2810 and/or in connection with the processor module 2810.

Turning to FIG. 29, a diagram 2900 is shown that illustrates a base station or eNB 110a configured for URFS band operation. The base station 110a may be configured to implement at least some of the features and functions described above with respect to FIGS. 1-18. For example, BS 110a may be capable of performing operations shown in FIG. 10. The base station 110a may include a processor module 2910, a memory module 2920, a transceiver module 2930, antennas 2940, and a base station modes module 2990. The base station 110 may also include one or both of a base station communications module 2960 and a network communications module 2970. Each of these components may be in communication with each other, directly or indirectly, over one or more buses 2905.

The memory module 2920 may include RAM and ROM. The memory module 2920 may also store computer-readable, computer-executable software (SW) code 2925 containing instructions that are configured to, when executed, cause the processor module 2910 to perform various functions described herein for using LTE-based communications in a URFS band. Alternatively, the software code 2925 may not be directly executable by the processor module 2910 but be configured to cause the computer, e.g., when compiled and executed, to perform functions described herein.

The processor module 2910 may include an intelligent hardware device, e.g., a CPU, a microcontroller, an ASIC, etc. The processor module 2910 may process information received through the transceiver module 2930, the base station communications module 2960, and/or the network communications module 2970. The processor module 2910 may also process information to be sent to the transceiver module 2930 for transmission through the antennas 2940, to the base station communications module 2960, and/or to the network communications module 2970. The processor module 2910 may handle, alone or in connection with the base station modes module 2990, various aspects of using LRFS-band-based communications in a URFS band.

The transceiver module 2930 may include a modem configured to modulate the packets and provide the modulated packets to the antennas 2940 for transmission, and to demodulate packets received from the antennas 2940. The transceiver module 2930 may be implemented as one or more transmitter modules and one or more separate receiver modules. The transceiver module 2930 may support communications in an LRFS band (e.g., LTE) and in a URFS band. The transceiver module 2930 may be configured to communicate bi-directionally, via the antennas 2940, with one or more UEs 120. The base station 110a may typically include multiple antennas 2940 (e.g., an antenna array). The base station 110a may communicate with a network controller 130-a through the network communications module 2970. The base station 110a may communicate with other base stations, such as the base station 110b and the base station 110c, using the base station communications module 2960.

According to the architecture of FIG. 29, the base station 110a may further include a communications management module 2950. The communications management module 2950 may manage communications with stations and/or other devices. The communications management module 2950 may be in communication with some or all of the other components of the base station 110a via the bus or buses 2905. Alternatively, functionality of the communications management module 2950 may be implemented as a component of the transceiver module 2930, as a computer program product, and/or as one or more controller elements of the processor module 2910.

The base station modes module 2990 may be configured to perform and/or control some or all of the functions or aspects described in FIGS. 10 related to using LRFS-band-based communications in a URFS band. For example, the base station modes module 2990 may be configured to support a supplemental downlink mode, a carrier aggregation mode, and/or a standalone mode. The base station modes module 2990 may include a Licensed module 2991 configured to handle LRFS band communications and an Unlicensed module 2992 configured to handle URFS band communications. The base station modes module 2990, or portions of it, may be a processor. Moreover, some or all of the functionality of the base station modes module 2990 may be performed by the processor module 2910 and/or in connection with the processor module 2910.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

As used herein, the expression “at least one of a or b” is meant to include a, b, or the combination of both a and b.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications, comprising:
determining a first component carrier, from a first set of component carriers within a licensed radio frequency spectrum band allocated between a plurality of operators;
determining a second component carrier, from a second set of component carriers within an unlicensed radio frequency spectrum band allocated between the plurality of operators; and
communicating using the first component carrier and the second component carrier.

2. The method of claim 1, further comprising determining the first component carrier based on one or more network conditions.

3. The method of claim 2, wherein determining the first component carrier based on one or more network conditions comprises, selecting a component carrier based on an amount of usage of another component carrier by another base station.

4. The method of claim 1, wherein a first frame transmitted using the first component carrier and a second frame transmitted using the second component carrier are time synchronized and the second frame is time asynchronous with frames transmitted using other component carriers of the second set of component carriers.

5. The method of claim 1, wherein a first frame transmitted using the first component carrier is time asynchronous with a second frame transmitted using the second component carrier and the second frame is time synchronized with frames transmitted using other component carriers of the second set of component carriers.

6. The method of claim 5, wherein:
the first and second frames are offset by a timing shift.

7. The method of claim 6, further comprising providing signaling to a user equipment (UE) indicating the timing shift.

8. The method of claim 7, wherein the signaling is provided on the first component carrier.

9. The method of claim 8, wherein the signaling indicates the time shift as an offset relative to at least one of: a system frame number (SFN) scale, a radio frame scale, or a subframe scale.

10. The method of claim 8, wherein the signaling further indicates at least a portion of the time shift as a fine offset value less than a subframe in duration.

11. The method of claim 7, wherein the signaling is provided via at least one of: a broadcast system information block, a clear channel assessment (CCA) exempt transmission (CET), or radio resource control (RRC) signaling.

12. The method of claim 7, further comprising:
determining an updated timing shift; and
providing signaling to the UE indicating the updated timing shift

13. The method of claim 6, further comprising receiving signaling indicating the timing shift.

14. The method of claim 13, wherein the signaling indicates the time shift as an offset relative to at least one of: a single frequency network (SFN) scale, a radio frame scale, or a subframe scale.

15. The method of claim 18, wherein the signaling indicates at least a portion of the time shift as a fine offset value less than a subframe in duration.

16. The method of claim 5, comprising receiving at least some control signaling on the second component carrier.

17. The method of claim 1, further comprising:
determining a time shift between a first frame transmitted using the first component carrier and a second frame transmitted using the second component carrier; and
utilizing the time shift when communicating using at least one of the first or second component carriers.

18. A method for wireless communications, comprising:
determining a first component carrier of a first operator, from a set of component carriers within an unlicensed radio frequency spectrum band allocated between a plurality of operators, wherein first frames transmitted using the first component carrier are time asynchronous with frames transmitted using other component carriers of the set of component carriers;
performing clear channel assessment (CCA) for transmission on the first component carrier; and
performing one or more actions when the clear channel assessment fails.

19. The method of claim 18, wherein performing the one or more actions comprises switching to a second component carrier from the set of component carriers.

20. The method of claim 18, wherein performing the one or more actions comprises changing a period in which the CCA is performed.

21. The method of claim 18, wherein performing CCA for transmission on the first component carrier comprises performing CCA window with a duration corresponding to a subframe duration.

22. An apparatus for wireless communications, comprising:
at least one processor configured to determine a first component carrier, from a first set of component carriers within a licensed radio frequency spectrum band allocated between a plurality of operators, determine a second component carrier, from a second set of component carriers within an unlicensed radio frequency spectrum band allocated between the plurality of operators, and communicate using the first component carrier and the second component carrier; and
a memory coupled with the at least one processor.

23. The apparatus of claim 22, wherein the at least one processor is further configured to determine the first component carrier based on one or more network conditions.

24. The apparatus of claim 23, wherein the at least one processor is configured to determine the first component carrier based on one or more network conditions comprises, selecting a component carrier based on an amount of usage of another component carrier by another base station.

25. The apparatus of claim 22, wherein a first frame transmitted using the first component carrier and a second frame transmitted using the second component carrier are time synchronized and the second frame is time asynchronous with frames transmitted using other component carriers of the second set of component carriers.

26. The apparatus of claim 22, wherein a first frame transmitted using the first component carrier is time asynchronous with a second frame transmitted using the second component carrier and the second frame is time synchronized with frames transmitted using other component carriers of the second set of component carriers

27. The apparatus of claim 22, wherein the at least one processor is further configured to:
determine a time shift between a first frame transmitted using the first component carrier and a second frame transmitted using the second component carrier; and
utilize the time shift when communicating using at least one of the first or second component carriers.

28. An apparatus for wireless communications, comprising:
at least one processor configured to determine a first component carrier of a first operator, from a set of component carriers within an unlicensed radio frequency spectrum band allocated between a plurality of operators, wherein first frames transmitted using the first component carrier are time asynchronous with frames transmitted using other component carriers of the set of component carriers, perform clear channel assessment (CCA) for transmission on the first component carrier, and perform one or more actions when the clear channel assessment fails; and
a memory coupled with the at least one processor.

29. The apparatus of claim 28, wherein the one or more actions comprise switching to a second component carrier from the set of component carriers.

30. The apparatus of claim 28, wherein the one or more actions comprise changing a period in which the CCA is performed.
